(19) United States
(12) Patent Application Publication
(10) Pub. No.: US 2017/0347279 A1
(43) Pub. Date: Nov. 30, 2017

(54) MONITORING AND MANAGEMENT OF eMBMS SYSTEMS

(71) Applicants: Yigal Bejerano, Springfield, NJ (US); Chandrasekharan Raman, Somerset, NJ (US); Tomas S. Young, Parsippany, NJ (US); Chun Nam Yu, Jersey City, NJ (US); Hugo A. Infante, New Providence, NJ (US); Yousef M. Abdelmalek, New Providence, NJ (US)

(72) Inventors: Yigal Bejerano, Springfield, NJ (US); Chandrasekharan Raman, Somerset, NJ (US); Tomas S. Young, Parsippany, NJ (US); Chun Nam Yu, Jersey City, NJ (US); Hugo A. Infante, New Providence, NJ (US); Yousef M. Abdelmalek, New Providence, NJ (US)

(73) Assignee: Alcatel-Lucent USA Inc., Murray Hill, NJ (US)

(21) Appl. No.: 15/337,050

(22) Filed: Oct. 28, 2016

Related U.S. Application Data
(60) Provisional application No. 62/342,336, filed on May 27, 2016.

(51) Int. Cl. H04W 24/02; H04W 4/02; H04L 12/26; H04L 12/801; H04W 72/00; H04W 28/02

(52) U.S. Cl. CPC H04W 24/02; H04W 72/005; H04W 28/0268; H04L 43/0829; H04L 47/29; H04W 4/028

(57) ABSTRACT

The present disclosure generally discloses dynamic monitoring and management capabilities for use in wireless communication systems. The dynamic monitoring and management capabilities may be configured to support dynamic monitoring and management within various types of contexts and associated environments. The dynamic monitoring and management capabilities may include feedback collection capabilities, service quality evaluation capabilities, parameter tuning capabilities, or the like, as well as various combinations thereof.

### CROSS-REFERENCE TO RELATED APPLICATIONS

This application claims the benefit of U.S. Provisional Patent Application Ser. No. 62/342,336, filed May 27, 2016, which is hereby incorporated herein by reference.

### TECHNICAL FIELD

The present disclosure relates generally to communication networks and, more particularly but not exclusively, monitoring and management in wireless communication networks.

### BACKGROUND

Long Term Evolution (LTE) evolved Multimedia Broadcast/Multicast Service (eMBMS) service has gained attention as an attractive solution for video delivery to large groups of User Equipments (UEs) in crowded areas. The deployment of the eMBMS system, however, is challenging due to the lack of real-time feedback from the UEs. As a result, the eMBMS service is provided without quality of service (QoS) guarantees and with limited resource utilization, due to the usage of conservative modulation and coding scheme (MCS) parameters. Additionally, other broadcast and multicast services that may be provided in other types of wireless networks also may suffer from similar problems.

### SUMMARY

The present disclosure generally discloses dynamic monitoring and management capabilities for use in wireless systems.

In at least some embodiments, an apparatus is provided. The apparatus includes a processor and a memory communicatively connected to the processor. The processor is configured to identify, from a set of wireless end devices served by a wireless access device, a special wireless end device from which feedback information is to be collected. The processor is configured to send, toward the special wireless end device, minimization of drive test (MDT) configuration information for configuring the special wireless end device to collect the feedback information. The processor is configured to receive, from the special wireless end device, the feedback information collected by the special wireless end device. In at least some embodiments, a non-transitory computer-readable storage medium stores instructions which, when executed by a computer, cause the computer to perform a corresponding method. In at least some embodiments, a corresponding method is provided.

In at least some embodiments, an apparatus is provided. The apparatus includes a processor and a memory communicatively connected to the processor. The processor is configured to operate in a first mode in which the wireless end device provides the feedback information to the network device using a first feedback reporting rate. The processor is configured to switch, based on receipt of configuration information, from the first mode to a second mode in which the wireless end device provides the feedback information to the network device using a second feedback reporting rate that is greater than the first feedback reporting rate. The processor is configured to operate in the second mode in which the wireless end device provides the feedback information to the network device using the second feedback reporting rate. The processor is configured to switch, based on identification of an end of a feedback period associated with the configuration information, from the second mode to the first mode. In at least some embodiments, a non-transitory computer-readable storage medium stores instructions which, when executed by a computer, cause the computer to perform a corresponding method. In at least some embodiments, a corresponding method is provided.

Various embodiments may be provided within the context of, or relate to, an Adaptive Multicast System (referred to herein as AMuSe).

### BRIEF DESCRIPTION OF THE DRAWINGS

The teachings herein can be readily understood by considering the following detailed description in conjunction with the accompanying drawings, in which:

FIG. 1 depicts an exemplary wireless communication system that is configured to support dynamic monitoring and management capabilities within the context of use of broadcast/multicast services of the wireless communication system for content delivery;

FIG. 2 depicts an embodiment of a method for use by a network device in controlling collection of feedback information from wireless end devices;

FIG. 3 depicts an embodiment of a method for use by a wireless access device in supporting collection of feedback information from wireless end devices;

FIG. 4 depicts a cellular wireless network configured to support various embodiments of AMuSe;

FIG. 5 depicts a cellular wireless network configured to support various embodiments of AMuSe;

FIG. 6 depicts groupings of users based on quality of service and associated feedback reporting rates for the groupings of users;

FIG. 7 depicts an embodiment of AMuSE configured to support probabilistic collection of feedback information from a wireless end device using AMuSe-Mobile-App;

FIG. 8 depicts an embodiment of a method for use by a wireless end device for collecting feedback information under the control of a network device and reporting the feedback information to the network device using AMuSe-Mobile-App;

FIG. 9 depicts an embodiment of AMuSE configured to support targeted collection of feedback information from a wireless end device using AMuSe-MDT-Based-Reports;

FIG. 10 depicts an embodiment of a method for use by a wireless end device for collecting feedback information under the control of a network device and reporting the feedback information to the network device using AMuSe-MDT-Based-Reports;

FIG. 11 depicts selection of special UEs for various embodiments of AMuSe;

FIG. 12 depicts an embodiment of a method for use by a wireless end device for switching between normal and special modes of operation for collection of feedback information and reporting of the feedback information to a network device;

FIG. 13 depicts differences between the AMuSe feedback mechanism variants as reflected by special UE locations; and

FIG. 14 depicts a high-level block diagram of a computer suitable for use in performing various functions described herein.

To facilitate understanding, identical reference numerals have been used, where possible, to designate identical elements that are common to the figures.

### DETAILED DESCRIPTION

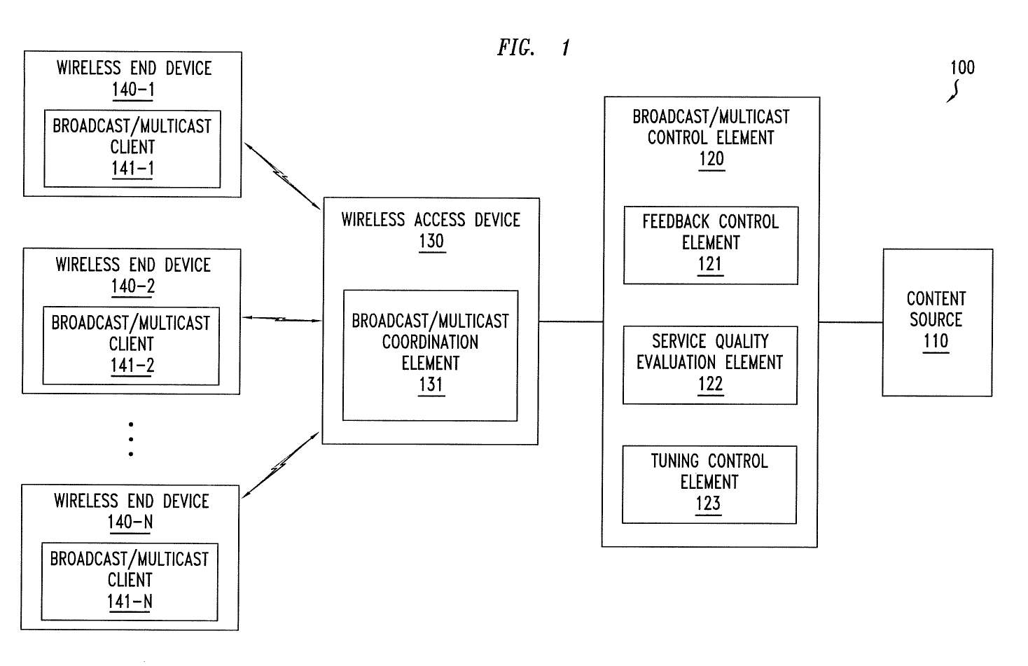

The present disclosure generally discloses dynamic monitoring and management capabilities for use in wireless communication systems. The dynamic monitoring and management capabilities for use in wireless communication systems may be configured to support dynamic monitoring and management within various types of contexts and associated environments, such as within the context of broadcast and multicast services provided in wireless networks (e.g., the evolved Multimedia Broadcast Multicast Service (eMBMS) service in Long Term Evolution (LTE) wireless networks or other types of broadcast and multicast services in other types of wireless networks) for delivery of content (e.g., video content, multimedia content, or the like), within the context of user experience control, within the context of machine-type-communication (MTC) or Internet-of-Things (IoT) environments, or the like, as well as various combinations thereof. The dynamic monitoring and management capabilities may include feedback collection capabilities, service quality evaluation capabilities, parameter tuning capabilities, or the like, as well as various combinations thereof. The dynamic monitoring and management capabilities may be implemented as an Adaptive Multicast System (AMuSe), embodiments of which are discussed further below. These and various other embodiments and potential advantages of the dynamic monitoring and management capabilities may be further understood by way of reference to the exemplary wireless communication system of FIG. 1.

FIG. 1 depicts an exemplary wireless communication system that is configured to support dynamic monitoring and management capabilities within the context of use of broadcast/multicast services of the wireless communication system for content delivery.

The wireless communication system 100 is configured to support delivery of content (e.g., video content, multimedia content, or the like) to wireless end devices (e.g., wireless user devices, IoT devices or the like). Multimedia content delivery, such as video clips, is an essential service for wireless networks. However, certain measurement studies have shown that video streaming over certain wireless networks (e.g., LTE networks) may not satisfy the demand in crowded areas. The inability to address the growing demand has led to several solutions that are based on dense deployment of access points (APs) or base stations (BSs) that provide dedicated delivery to wireless end devices; however, such solutions require high capital and operational expenditure and may suffer from extensive interference between adjacent devices. Wireless multicast offers another approach for delivering multimedia content to large groups, where the users share common interests. This is the case in sports arenas, entertainment centers, lecture halls, and transportation hubs, where users are interested in venue specific content. However, in cellular networks (e.g., LTE) as well as IEEE 802.11 (WiFi) networks, multicast services are provided without quality of service (QoS) guarantees due to the lack of feedback from the wireless end devices. Consequently, typically only limited multicast services are provide at relatively low bit rates (e.g., at 6 Mbps for 802.11a/g).

The wireless communication system 100, as discussed further below, may be configured to overcome such problems or potential problems associated with delivery of content to groups of wireless end devices by supporting dynamic monitoring and management capabilities within the context of use of broadcast/multicast services of the wireless communication system for content delivery to wireless end devices. The dynamic monitoring and management capabilities may include feedback collection capabilities, which may include controlling collection of feedback from wireless end devices in a probabilistic manner. The dynamic monitoring and management capabilities may include feedback collection capabilities, which may include evaluation of the service quality based on evaluation of feedback information collected from the wireless end devices. The dynamic monitoring and management capabilities may include parameter tuning capabilities, which may include dynamically adapting video control, dynamically adapting transmission parameters (e.g., Modulation and Coding Scheme (MCS), forward error correction (FEC), or the like), or the like, as well as various combinations thereof.

The wireless communication system 100 includes a content source (CS) 110, a broadcast/multicast control element (BMCE) 120, a wireless access device (WAD) 130, and a set of wireless end devices (WEDs) 140-1-140-N (collectively, WEDs 140).

The CS 110 is configured to provide content 111 that will be delivered to WEDs 140 via BMCE 120 and WAD 130. The content 111 may include video content, multimedia content, or the like. The content 111 may be stored by CS 110 or obtained by CS 110 from one or more other content sources. The CS 110 may support various video processing capabilities (e.g., video coding capabilities or the like). The CS 110 provides content 111 to the BMCE 120 for delivery to WEDs 140 using broadcast/multicast services. The CS 110 may be configured to dynamically control delivery of content 111 to the BMCE 120, for delivery to WEDs 140 using broadcast/multicast services, based on content control information received from the BMCE 120 (e.g., which may be determined by the BMCE 120 based on various capabilities supported by the BMCE 120, such as feedback collection capabilities, service evaluation capabilities, or the like). The CS 110 may be configured to support various other capabilities.

The BMCE 120 is configured to support delivery of content 111 of the CD 110 to WEDs 140 via the WAD 130 using broadcast/multicast services. The BMCE 120 includes a feedback control element (FCE) 121 that is configured to control collection of feedback information from WEDs 140, a service evaluation element (SEE) 122 that is configured to evaluate the service provided to WEDs 140 in delivering the content 111 of the CD 110 to WEDs 140 via the WAD 130, and a tuning control element (TCE) 123 that is configured to provide dynamic parameter tuning for dynamically controlling (and improving or even optimizing) the delivery of the content 111 of the CD 110 to WEDs 140 via the WAD 130. The BMCE 120 may be configured to support various other capabilities.

The WAD 130 is a wireless access device configured to operate as a point of wireless access for the WAD 130. The WAD 130 supports an air interface for WEDs 140 and is communicatively connected to BMCE 120. The WAD 130 is configured to support delivery of the content 111 of the CD 110 to WEDs 140 based on the broadcast/multicast service supported by BMCE 120. The WAD 130 also may be configured to support delivery of other types of content (e.g., unicast content) to WEDs 140, propagation of information sourced by the WEDs 140, exchange of control information with WEDs 140, and so forth. The WAD 130 includes a broadcast/multicast coordination element (BMCE) 131. The BMCE 131 is configured to support collection of feedback information from WEDs 140 under the control of FCE 121 of BMCE 120 (e.g., propagating feedback collection instructions from BMCE 130 to WEDs 140, propagating feedback information received from WEDs 140 upstream toward BMCE 120 for processing by SEE 122 of BMCE 120, or the like). The WAD 130 may be configured to support various other capabilities.

The WEDs 140 include wireless end devices configured for wireless communication via wireless access devices (illustratively, WAD 130). The WEDs 140 are configured to receive the content 111 of the CD 110 based on the broadcast/multicast service supported by BMCE 120. The WEDs 140 may be configured to handle the received content 111 of the CD 110 in various different ways (e.g., storing the received content 111, processing the received content 111, presenting the received content 111 via one or more presentation interfaces, or the like, as well as various combinations thereof). The WEDs 140 may be configured to receive and send other types of content (e.g., unicast content) via the WAD 130, support exchange of control information via the WAD 130, and so forth. The WEDs 140-1-140-N include broadcast/multicast client elements (BMCEs) 141-1-141-N (collectively, BMCEs 141), respectively. The BMCEs 141 are configured to collect feedback information under the control of FCE 121 of BMCE 120 and to propagate the collected feedback information for delivery to BMCE 120 for processing by SEE 122 of BMCE 120. The WEDs 140 may include wireless end devices (e.g., smartphones, tablets, laptops, or the like), IoT devices or other types of machine-type-communication (MTC) devices (e.g., machines, sensors, appliances, or the like), or the like, as well as various combinations thereof. The WEDs 140 each may be configured to support various other capabilities.

The wireless communication system 100, as indicated above, is configured to support dynamic collection of feedback information from WEDs 140.

The wireless communication system 100 is configured to support determination and propagation of feedback collection instruction information for dynamic collection of feedback information from WEDs 140. The BMCE 120 is configured to determine feedback collection instruction information and to send the feedback collection instruction information toward the WAD 130 for delivery to WEDs 140. The WAD 130 is configured to receive the feedback collection instruction information from BMCE 120 and to send the feedback collection instruction information toward WEDs 140. The WEDs 140 are configured to receive the feedback collection instruction information from WAD 130. The feedback collection instruction information may be propagated from the BMCE 120 to WEDs 140 using a broadcast capability, a multicast capability, or the like. The feedback collection instruction information may be determined based on previously received feedback information received from WEDs 140. The feedback collection instruction information may include a set of one or more quality thresholds and an associated set of one or more feedback collection probabilities, respectively. The feedback collection probability associated with a corresponding quality threshold is a probability that a WED 140 is to provide feedback information to BMCE 120 based on a determination that a measured quality level of the WED 140 does not satisfy the quality threshold. The quality thresholds and the associated feedback collection probabilities may be arranged such that WEDs 140 having lower quality (e.g., in terms of SNR or other types of quality measures) having a higher probability of reporting feedback information. The feedback collection instruction information may include, for one or more quality thresholds, one or more additional conditions that must be met by a WED 140 before the WED 140 applies the associated feedback collection probability for determining whether to provide feedback information to BMCE 120. The one or more additional conditions may include a location condition (e.g., a WED 140 must be located within a certain cell, within a certain geographic area, or the like), a time condition (e.g., the current time is during a reporting interval, a time period during which an event is taking place, or the like), a device status condition (e.g., a WED 140 must have a particular device status), or the like, as well as various combinations thereof. The feedback collection instruction information may include, for one or more quality thresholds, an indication of the feedback information to be collected. The feedback information to be collected may include WED identification information, WED location information, QoS information (e.g., radio frequency (RF) signal measurement information, information indicative of packets received and lost, or the like), or the like, as well as various combinations thereof. The feedback collection instruction information may include, for one or more quality thresholds, an indication of a feedback reporting rate (which also may be referred to as a feedback rate or a reporting rate) at which feedback information is to be reported (e.g., one feedback message per reporting interval, three feedback messages per reporting interval, or the like). The feedback collection instruction information may include various other types of information configured for use in controlling dynamic collection of feedback information from WEDs 140.

The wireless communication system 100 is configured to support collection and propagation of feedback information collected from WEDs 140 for delivery to BMCE 120. The WEDs 140 are configured to collect feedback information based on feedback collection instruction information received from BMCE 120 via the WAD 130. The WEDs 140 are configured to send the feedback information toward WAD 130 for delivery to BMCE 120. The WAD 130 is configured to receive the feedback information from WEDs 140 and to send the feedback information to BMCE 120. The BMCE 120 is configured to receive the feedback information from the WAD 130. The feedback information of WEDs 140 may be communicated from the WEDs 140 to the BMCE 120 using unicast communications. The BMCE 120 is configured to process the feedback information. The BMCE 120 may process the feedback information for various purposes (e.g., to perform service quality evaluation processing for evaluating the QoS being provided to WEDs 140 during delivery of broadcast/multicast services to WEDs 140, to dynamically tune parameters associated with delivery of broadcast/multicast services to WEDs 140, to modify feedback collection instruction information to be provided to the WEDs 140 for future collection of feedback information, or the like, as well as various combinations thereof. The feedback information may include WED identification information, WED location information, QoS information (e.g., RF signal measurement information, information indicative of packets received and lost, or the like), or the like, as well as various combinations thereof. The feedback information may include various other types of information configured for use by the BMCE 120 in providing various control functions.

The wireless communication system 100, as indicated above, is configured to support service quality evaluation for evaluating the QoS provided to WEDs 140. The service quality evaluation may be performed by BMCE 120 based on feedback information received by BMCE 120 from the WEDs 140.

The wireless communication system 100, as indicated above, is configured to support dynamic parameter tuning for controlling the QoS provided to WEDs 140. The dynamic parameters tuning may be controlled by BMCE 120 based on the service quality evaluation performed by BMCE 120 for evaluating the QoS provided to WEDs 140.

The wireless communication system 100, as indicated above, may be implemented based on various types of wireless technologies (e.g., Second Generation (2G) cellular technologies, Third Generation (3G) cellular technologies, Fourth Generation (4G) cellular technologies such as LTE or LTE-Advanced), Fifth Generation (5G) cellular technologies, or the like). It will be appreciated that, depending on the type of wireless technology that is used, the various elements of the wireless communication system 100 may be implemented as, or as part of, elements of the wireless technology that is used. For example, within the content of an LTE system using eMBMS services, the BMCE 120 may be referred to as a Broadcast Multicast Service Center (BMSC), WAD 130 may be referred to as an evolved NodeB (eNodeB), and WEDs 140 may be referred to as User Equipments (UEs).

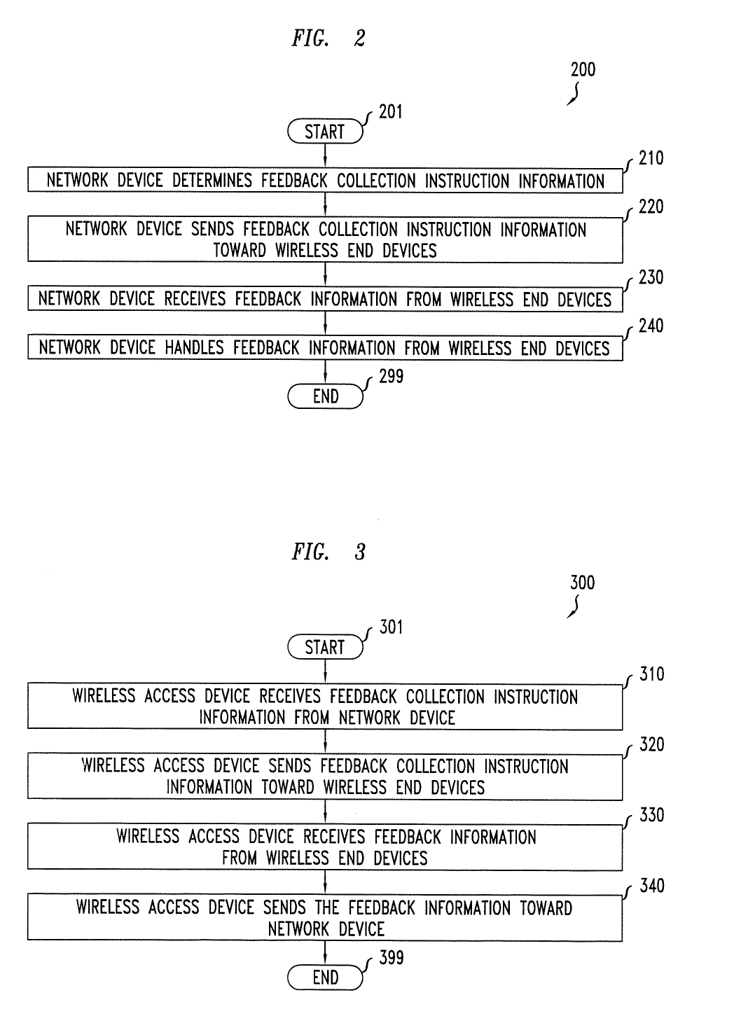

FIG. 2 depicts an embodiment of a method for use by a network device in controlling collection of feedback information from wireless end devices. It is noted that, although presented herein as being performed serially, at least a portion of the functions of method 200 may be performed contemporaneously or in a different order than as presented. It also will be appreciated that various portions of the functions of method 200 may be split into separate processes or organized or implemented in other ways. At block 201, method 200 begins. At block 210, the network device determines feedback collection instruction information. At block 220, the network device sends the feedback collection instruction information toward wireless end devices (e.g., toward a wireless access device serving the wireless end devices). At block 230, the network device receives feedback information from wireless end devices. At block 240, the network device handles the feedback information from wireless end devices (e.g., stores the feedback information, processes the feedback information, further propagates the feedback information, or the like). At block 299, method 200 ends.

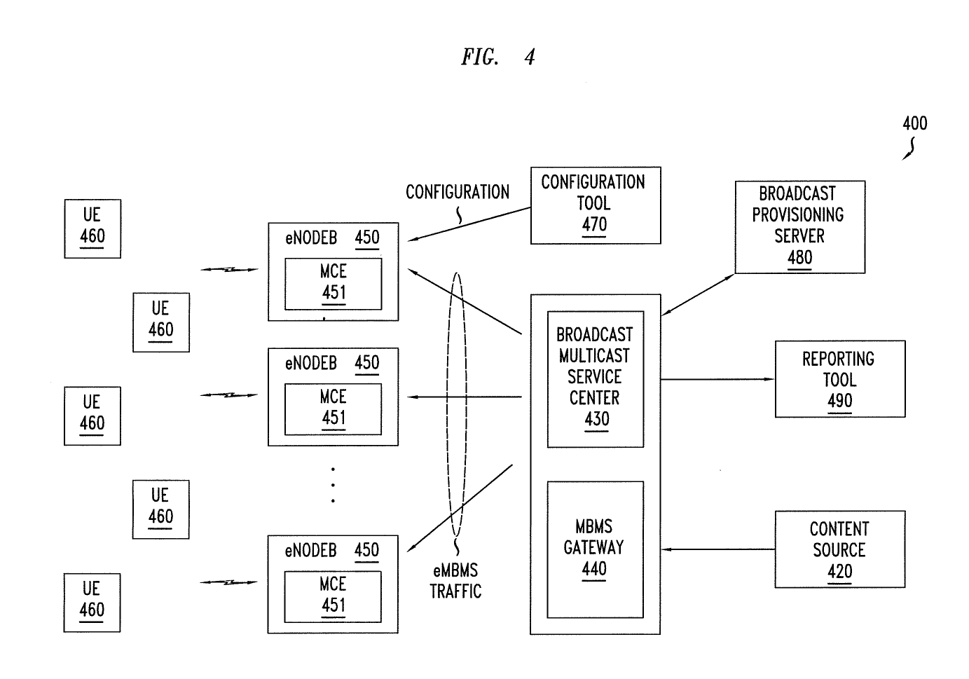

FIG. 3 depicts an embodiment of a method for use by a wireless access device in supporting collection of feedback information from wireless end devices. It is noted that, although presented herein as being performed serially, at least a portion of the functions of method 300 may be performed contemporaneously or in a different order than as presented. It also will be appreciated that various portions of the functions of method 300 may be split into separate processes or organized or implemented in other ways. At block 301, method 300 begins. At block 310, the wireless access device receives feedback collection instruction information from a network device. At block 320, the wireless access device sends the feedback collection instruction information toward wireless end devices. At block 330, the wireless access device receives feedback information from wireless end devices. At block 340, the wireless access device sends the feedback information toward the network device. At block 399, method 300 ends.

Various embodiments of the dynamic monitoring and management capabilities presented above may be implemented in various ways. In at least some embodiments, for example, various dynamic monitoring and management capabilities presented above may be implemented based on an Adaptive Multicast System (AMuSe) which is depicted and described further herein with respect to FIGS. 4-13.

In at least some embodiments, various dynamic monitoring and management capabilities presented above may be implemented based on an Adaptive Multicast System (AMuSe).

In at least some embodiments, AMuSe is configured to provide simple and effective solutions to optimize eMBMS network parameters while also ensuring high service quality to the UEs. In at least some embodiments, AMuSe is configured to utilize a low-overhead feedback mechanism that collects limited, yet sufficient, status reports from the UEs. These reports may be used for analyzing the service quality provided to the users and for root cause analysis in events of service quality degradation. In at least some embodiments, AMuSe is configured to, based on such analysis, recommend the appropriate parameter settings for eMBMS network parameters (e.g., the eMBMS MCS, FEC codes, or the like). It is noted that, for supporting gradual deployment of AMuSe, service operators may be able to choose manual or automatic parameter tuning.

In at least some embodiments, AMuSe is configured to support efficient video delivery to very large groups of UEs. In at least some embodiments, AMuSe may be a software self-organizing-network (SON) feature deployed in the network core. In at least some embodiments, AMuSe may be implemented as a stand-alone server, a software module of the eMBMS Broadcast Multicast Service Center (BMSC), a software module on a cloud service, or the like.

In at least some embodiments, AMuSe is configured to perform dynamic eMBMS parameter tuning. In at least some embodiments, AMuSe is configured to perform dynamic eMBMS parameter tuning by iteratively performing tasks of feedback collection, service quality evaluation based on the feedback collection, and eMBMS parameter tuning based on the service quality evaluation.

In at least some embodiments, as noted above, AMuSe is configured to perform dynamic eMBMS parameter tuning based on feedback collection. AMuSe may efficiently collect service quality reports from selected UEs based on a probabilistic feedback node selection process that is configured to ensure both appropriate feedback as well as low communication overhead. In at least some embodiments, feedback collection may be based on a Mobile-App deployed on each UE that offers flexible configuration of the required status information and feedback reporting rate. In at least some embodiments, feedback collection may be based on MDT-Based-Reports which may be based on the recent extensions of the minimization of drive tests (MDT) standard.

In at least some embodiments, as noted above, AMuSe is configured to perform dynamic eMBMS parameter tuning based on service quality evaluation based on the feedback collection. AMuSe may use UE service quality reports to analyze the spatial and temporal service quality provided to the UEs according to different metrics. AMuSe may use UE service quality reports to (1) analyze the spatial and temporal service quality provided to the UEs according to different metrics and (2) recommend the appropriate eMBMS parameter configuration based on analysis of the spatial and temporal service quality provided to the UEs according to different metrics.

In at least some embodiments, as noted above, AMuSe is configured to perform dynamic eMBMS parameter tuning based on eMBMS parameter tuning based on the service quality evaluation. AMuSe, after determining the desired eMBMS setting, may reconfigure eMBMS components for improving or optimizing the system performance.

It will be appreciated that AMuSe may be deployed in various ways. In a first phase (denoted as AMuSe-Off-Line), for example, AMuSe may be used as a reporting tool that collects service quality reports from the UEs and provides instantaneous static analysis of the UE experience and that also suggests eMBMS parameter configurations. In a second phase (denoted as AMuSe-On-Line), for example, AMuSe may serve as a Self-Organizing Network (SON) tool for dynamic configuration of eMBMS parameters.

Various embodiments of AMuSe, and associated AMuSe deployments discussed above, may overcome various deficiencies or disadvantages of eMBMS services. Various embodiments of AMuSe may simplify eMBMS planning and deployment (e.g., since AMuSe collects real measurements from selected eMBMS receivers, AMuSe reduces the need for rigorous network planning and extensive drive tests; rather, the eMBMS system can be deployed with conservative settings after a rudimentary network planning and AMuSe will then operate to improve the system performance over time). Various embodiments of AMuSe may support detailed analysis of service performance (e.g., AMuSe-Off-Line analyzes the UE feedback messages and produces reports of the special and temporal service quality observed by the UEs, and these reports enable improvements to the system performance between events and detection of environmental changes, such as equipment failures and interfering cells). Various embodiments of AMuSe may support dynamic tuning of eMBMS parameters (e.g., AMuSe-On-Line leverages the statistics and recommendations provided AMuSe-Off-Line for instantaneous optimization or near instantaneous optimization of the system performance.

Various embodiments of AMuSe may be further understood by considering such embodiments within the context of an LTE-Advanced network with multiple eNodeBs (eNBs) that provide eMBMS services in a crowded venue, e.g., a sport arena, a shopping center, an amusement park, or the like.

The eMBMS video distribution is typically offered as an unidirectional service without feedback from the UE or retransmissions of lost packets. To compensate for the lack of loss recovery mechanism and for improving the spectral efficiency, eMBMS typically supports the Multicast Broadcast Single Frequency Network (MBSFN) concept, where multiple adjacent eNBs perform synchronized downlink transmission of the multicast content. The eMBMS receivers listen to the selected eMBMS bearer and perform soft combination of the eMBMS signals of their adjacent eNBs. We refer to this set of eNBs as MBSFN set and their overall service area is termed the MBSFN area. For avoiding interference from adjacent cells, the eNBs near the boundary of the MBSFN area are used as a protection tier (and should not include eMBMS receivers in their coverage areas).

The eNBs, as indicated above, may define a single MBSFN set with a given number of protection tiers. The eMBMS services are provided and managed by a single BMSC.

FIG. 4 depicts a cellular wireless network configured to support various embodiments of AMuSe.

The cellular wireless network 400 includes various elements relevant for implementation of AMuSe. The cellular wireless network 400 includes a broadcast provisioning server (BPS) 410, a content source (CS) 420, a broadcast multicast service center (BMSC) 430, an MBMS gateway 440, eNodeBs 450 (including multicast coordination entities (MCEs) 451, respectively), UEs 460, a configuration tool (CT) 470, and a reporting tool (RT) 480. The BPS 410 allows the service operator to define broadcast events by providing the following information: the event location and duration, content source (illustratively, CS 420), and required QoS metrics. The event specifications are provided to the BMSC 430, which is the content ingestion point for broadcast or multicast based propagation of the content to be delivered to the UEs 450. The BMSC 430 retrieves the content from CS 420 and prepares it for broadcast transmission. The BMSC 430 maps the content to appropriate eMBMS bearers and forwards the content to the MBMS gateway 440, which distributes the content to the all of the eNBs 450 in the service area of the session. Once the broadcast flow arrives to the eNodeBs 450, the eNodeBs 450, with the aid of the MCEs 451, synchronize their transitions and send an identical eMBMS signal by using the same MCS at the same time and frequency. It is noted that this is based on an assumption that a distributed MCE implementation (i.e., each eNodeB has its own MCE element) is being used; however, it will be appreciated that other MC implementations may be used. The UEs 460 that are operating as eMBMS receivers listen to selected eMBMS bearers and integrate signals received from adjacent eNodeBs 450. The CT 470 is configured to configure the eNodeBs 460 to support the eMBMS flows. The RT 480 is configured to provide information about the system performance to the operator.

In the network model, assume a dense UE population of n UEs, also referred to as eMBMS receivers, which consume eMBMS services for a relatively long duration of time. The UEs are capable of detecting and reporting the eMBMS service quality that they experience, both from the aspects of radio frequency (RF) signal as well as packet reception. In addition, the UEs are able to infer their locations to a certain degree of accuracy (e.g., using Global Navigation Satellite System (GNSS) or other suitable mechanisms).

Various embodiments of AMuSe may be further understood by considering such embodiments within the context of meeting or attempting to meet a particular objective within an LTE-Advanced network. It is assumed that, given a packet delivery ratio (PDR) threshold (PDR-threshold), L (e.g., L=90%, 92%, or the like): (1) any UE with pre-FEC PDR above L benefits from high QoS and (2) any UE with pre-FEC PDR below L suffers from poor service (and is termed an outlier). The goal of the AMuSe system may be defined by the following multi-requirement objective: design a practical, efficient, and dynamic eMBMS parameter tuning system that satisfies the following requirements: (1) high throughput (e.g., operate at the highest possible MCS, i.e., called the target MCS, with appropriate FEC and protection tier, while preserving SLAs), (2) meet SLAs (e.g., given a PDR-threshold L, e.g., L=95%, and Population-Threshold X, e.g., X=99%, the selected MCS should guarantee that at least a fraction X of the receivers experience PDR above L (i.e., are not outliers) where it is noted that, except for short transition periods, this requirement poses an upper bound of A_{max=[η(1-X)]} on the number of permitted outliers with PDR below L), (3) scalability (e.g., the system should be able to support tens of thousands of UEs in a MBSFN area, (4) stability (e.g., avoid eMBMS parameter changes due to sporadic changes of the channel condition), (5) fast convergence (e.g., fast adaptation to the target MSC and the other eMBMS parameters after long lasting changes of the environment (e.g., user mobility or network changes)), and (6) standards and technology compliance (e.g., no change to the 3GPP standards or to the operating system of the UEs). It is noted that, in at least some embodiment, at least some of the foregoing objectives may be modified or ignored.

In at least some embodiments, AMuSe may be configured to perform the following tasks: (1) feedback collection, (2) service quality evaluation, and (3) parameter tuning.

In at least some embodiments, AMuSe may be configured to perform feedback collection. AMuSe may efficiently collect service quality reports from the UEs by using a probabilistic feedback collection mechanism. AMuSe may instruct the UEs about the information to be provided by the UEs (e.g., the UE location, RF measurements, received and lost packets, or the like) and the feedback reporting rate of the UEs. It will be appreciated that, at any given time, only a small set of UEs (referred to as Feedback (FB) Nodes) send service quality reports. For collecting sufficient reports with low communication overhead, UEs that experience low service quality send frequent reports, while the other UEs send infrequent reports.

In at least some embodiments, AMuSe may be configured to perform service quality evaluation. AMuSe uses the UE feedback to estimate the spatial and temporal service quality that the UEs experience according to different metrics, such as the eMBMS SNR and pre-FEC PDR. The UE feedback reports allow AMuSe to infer the fraction of UEs that suffer from weak service quality as well as poor service spots in the MBSFN area. This information may then be used for deciding the proper configuration of the eMBMS parameters (e.g., eMBMS MCS, FEC, video coding, MBSFN protection tier, or the like) for optimizing the network performance while ensuring high QoS.

In at least some embodiments, AMuSe may be configured to perform parameter tuning. AMuSe, after determining the desired eMBMS parameter settings, reconfigures the network components to support use of the desired eMBMS parameter settings by sending appropriate instructions to network components and/or to eMBMS provisioning mechanisms.

In at least some embodiments, AMuSe may be configured to iteratively perform feedback collection, service quality evaluation, and parameter tuning in order to refine the eMBMS parameters to cope with the dynamic nature of the network (e.g., UE mobility).

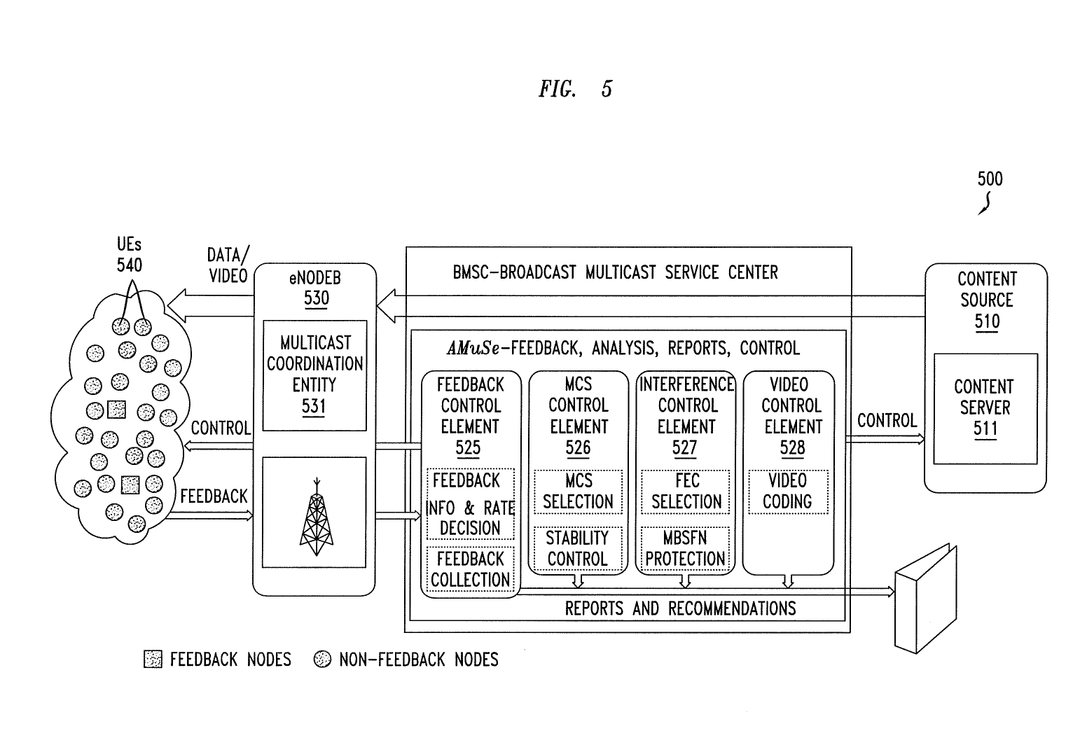

FIG. 5 depicts a cellular wireless network configured to support various embodiments of AMuSe. The cellular wireless network 500 includes a content source (CS) 510, a broadcast multicast service center (BMSC) 520, an eNodeB 530, and a set of UEs 540. The CS 510, the BMSC 520, the eNodeB 530, and the UEs 540 may correspond to CS 110, BMCE 120, WAD 130, and WEDs 140 of FIG. 1, respectively. The CS 510 includes a content server (CS) 511. The BMSC 520 includes an AMuSe element 521. The AMuSe element 521 includes a feedback control element (FCE) 525, an MCS control element (MCE) 526, an interference control element (ICE) 527, and a video control element (VCE) 528. The eNodeB 530 includes a multicast coordination entity (MCE) 531. The CS 511 of CS 510 is configured to stream multimedia content for delivery to UEs 540. The BMSC 520 is configured to leverage multicast capabilities of cellular wireless network 500, such as the LTE eMBMS service, for fast distribution of instructions to large groups of UEs. The BMSC 520 is configured to support use of probabilistic group instructions or targeted instructions for controlling collection of feedback information from UEs 540. In either case, it is expected that only a subset of the UEs 540 will become feedback nodes during any given reporting interval. This is illustrated in FIG. 5 using different shapes for the UEs 540: the square shaped UEs 540 have become feedback nodes, whereas the circle shaped UEs 540 have not become feedback nodes. It will be appreciated that the reasons for which the circle shaped UEs 540 have not become feedback nodes may vary for the embodiments related to probabilistic collection of feedback information as in embodiments of Mobile-App (e.g., either the specified conditions were not satisfied or the specified conditions were satisfied but the UEs 540 did not become feedback nodes due to the application of the probability) and for the embodiments related to targeted collection of feedback information as in embodiments of Mobile-MDT-Based-Reports (e.g., the UEs 540 were not selected by the network device to be feedback nodes).

The FCE 525 is configured to instruct the UEs 540 about the required feedback information and the feedback reporting rate. The FCE 525 also is configured to receive and store the UE feedback reports from the UEs 540.

The MCE 526 is configured to evaluate the eMBMS SNR and PDR reports of the UEs 540 for determining the target MCS. The MCE 526 may be configured to analyze whether packet losses result from interference or from poor channel condition. The MCS selection also may be based on network stability for avoiding frequent changes of the eMBMS parameters, as such frequent changes may hinder the service quality.

The ICE 527 is configured to handle packet losses related to interference (excluding poor channel). The ICE 527 is configured to detect noise sources and determine appropriate actions to overcome interferences caused by such noise sources, such as adapting the FEC level, modifying the protection tier of the MBSFN, or the like.

The VCE 528 is configured to address video quality related issues. The VCE 528 may be configured to, given the available wireless resources as well as the selected MCS and FEC, determine optimal video coding for efficient utilization of the wireless resources without over-provisioning.

The MCE 531 of eNodeB 530 may be configured to provide various coordination functions for supporting monitoring and management functions performed by BMSC 520.

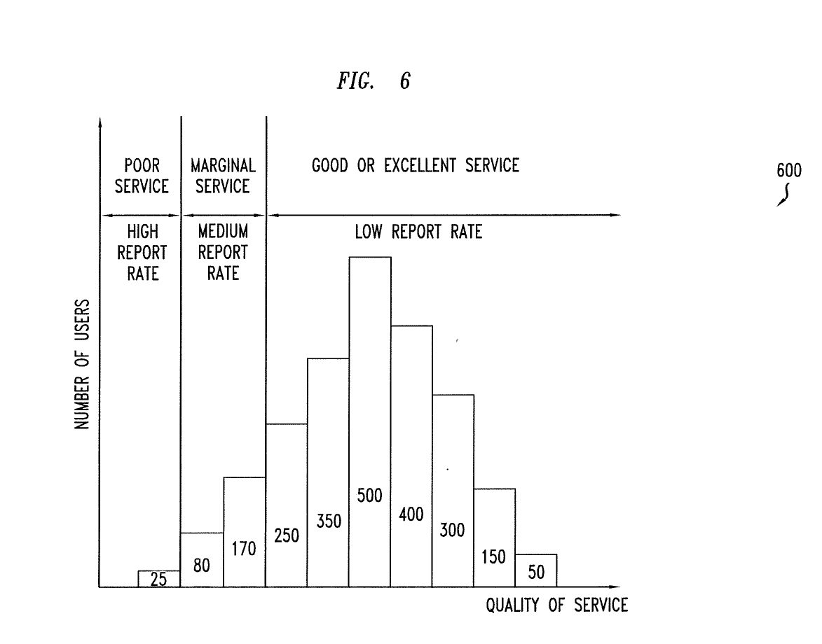

In at least some embodiments, AMuSe may be configured to perform feedback collection. AMuSe may be configured to collect sufficient service quality reports from the UEs (e.g., sufficient for performance analysis) with low communication overhead. To this end, AMuSe may be configured to instruct the UEs regarding the required information to be collected (e.g., RF measurements of the eMBMS service and packet loss statistics) and the feedback reporting rate. AMuSe may be configured to control the amount of status messages at each cell by selecting at any given time only a small fraction of the UEs as FB nodes for sending their feedback. Any selected FB node may send status messages at a predefined rate (e.g., once a second, twice a second or the like), and returns to operate as normal UE until it is selected again. FIG. 6 illustrates the FB node selection criteria as a function of the service quality that the UE experience, which may be used by AMuSe for determining the feedback message rate. Since AMuSe is configured to ensure a bound on the number of outliers, UEs with relatively low service quality are frequently selected as FB nodes, while UEs with relatively high service quality are infrequently selected as FB nodes. It is noted that the feedback collection mechanism may be realized in a number of ways (including an embodiment discussed further below that is referred to as AMuSe-Mobile-App and an embodiment discussed further below that is referred to as AMuSe-MDT-Based-Reports).

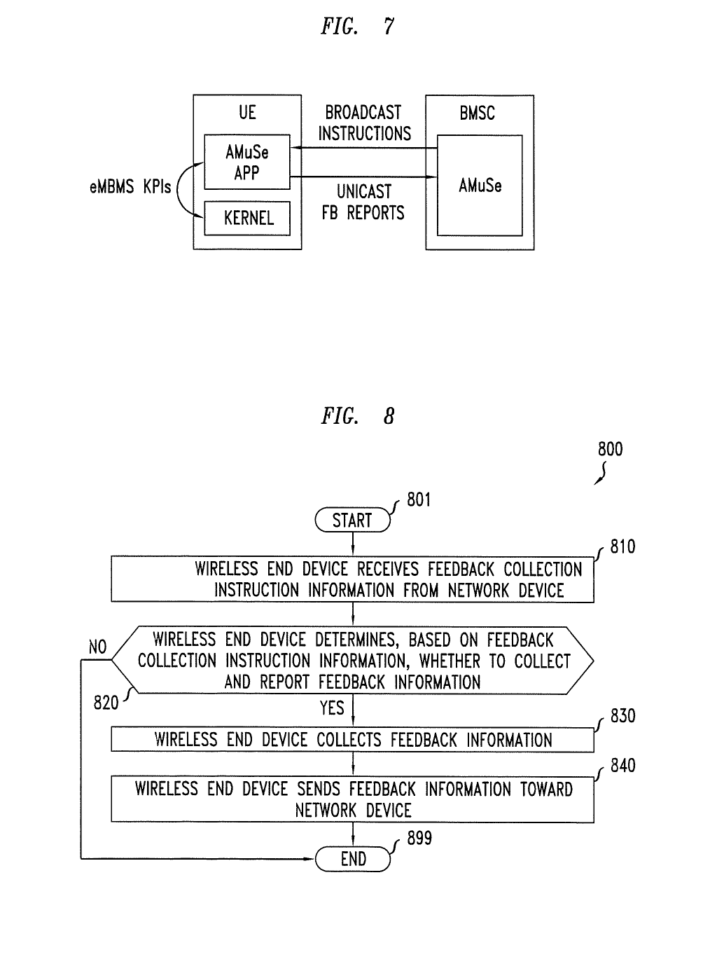

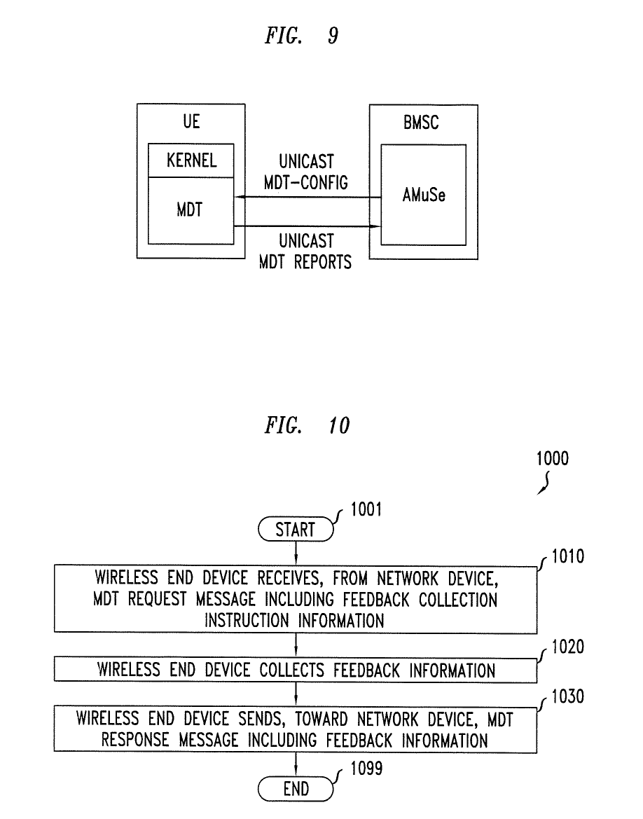

In at least some embodiments (which also may be referred to as AMuSe-Mobile-App), the FB mechanism may be realized using mobile applications installed on the UEs. A mobile application is installed on all of the UEs and each UE listens to AMuSe control instructions, which also may be sent as multicast messages. The FB node selection is done by a quasi-distributed stochastic process in which AMuSe instructs the UEs regarding the probability that one of the UEs should become a FB node as a function of the service quality (e.g., the eMBMS SNR or the like) that is experienced by UE. In response, each UE independently determines whether it should serve as FB node for the given period of time (e.g., a few seconds or other suitable period of time). It is noted that such embodiments have low communication overhead and provide flexible control on the feedback reporting rate and the reported information. It is further noted that such embodiments can be implemented on current UEs, but that collaboration with UE vendors is needed. An example embodiment is depicted in FIG. 7, which depicts an embodiment of AMuSE configured to support probabilistic collection of feedback information from a wireless end device using AMuSe-Mobile-App. A corresponding method for use by a wireless end device for collecting feedback information under the control of a network device and reporting the feedback information to the network device is presented with respect to FIG. 8.

FIG. 8 depicts an embodiment of a method for use by a wireless end device for collecting feedback information under the control of a network device and reporting the feedback information to the network device. It is noted that, although presented herein as being performed serially, at least a portion of the functions of method 800 may be performed contemporaneously or in a different order than as presented in method 800 of FIG. 8. It also will be appreciated that various portions of the functions of method 800 may be split into separate processes or organized or implemented in other ways.

At block 801, method 800 begins.

At block 810, the wireless end device receives feedback collection instruction information from a network device. The feedback collection instruction information may include one or more conditions and a feedback probability. The one or more conditions may include a service quality condition (e.g., service quality of the wireless end device satisfying a service quality threshold specified in the feedback collection instruction information) and, optionally, one or more additional conditions (e.g., a location condition, a time condition, or the like, as well as various combinations thereof). The feedback probability is a probability that the wireless end device is to collect and report feedback information based on a determination that the one or more conditions are satisfied. The feedback collection instruction information also may include an indication of the feedback information to be collected (e.g., wireless end device identification information, wireless end device location information, QoS information, or the like, as well as various combinations thereof), an indication of a feedback reporting rate at which feedback information is to be reported, or the like, as well as various combinations thereof.

At block 820, the wireless end device determines, based on the feedback collection instruction information, whether to collect and report feedback information. The determination as to whether to collect and report feedback information may be based on one or more conditions specified in feedback collection instruction information. The one or more conditions include a service quality condition (e.g., service quality of the wireless end device satisfying a service quality threshold specified in the feedback collection instruction information) and, optionally, one or more additional conditions (e.g., a location condition, a time condition, or the like, as well as various combinations thereof). If any of the required conditions for feedback collection and reporting are not satisfied, a determination is made that feedback is not to be collected or reported by the wireless end device and, thus, method 400 proceeds to block 499, where method 400 ends. If the required conditions for feedback collection and reporting are satisfied, then the determination as to whether to collect and report feedback information may be further based on a feedback probability specified in the feedback collection instruction information. If a determination is made, based on the feedback probability, that feedback is not to be collected or reported by the wireless end device, then method 800 proceeds to block 899, where method 800 ends. If a determination is made, based on the feedback probability, that feedback is to be collected and reported by the wireless end device, then method 800 proceeds to block 830.

At block 830, the wireless end device collects feedback information. The wireless end device may collect the feedback information based on the feedback collection instruction information. The feedback information may include wireless end device identification information, wireless end device location information, QoS information (e.g., RF signal measurement information, information indicative of packets received and lost, or the like), or the like, as well as various combinations thereof.

At block 840, the wireless end device sends the feedback information toward the network device.

At block 899, method 800 ends.

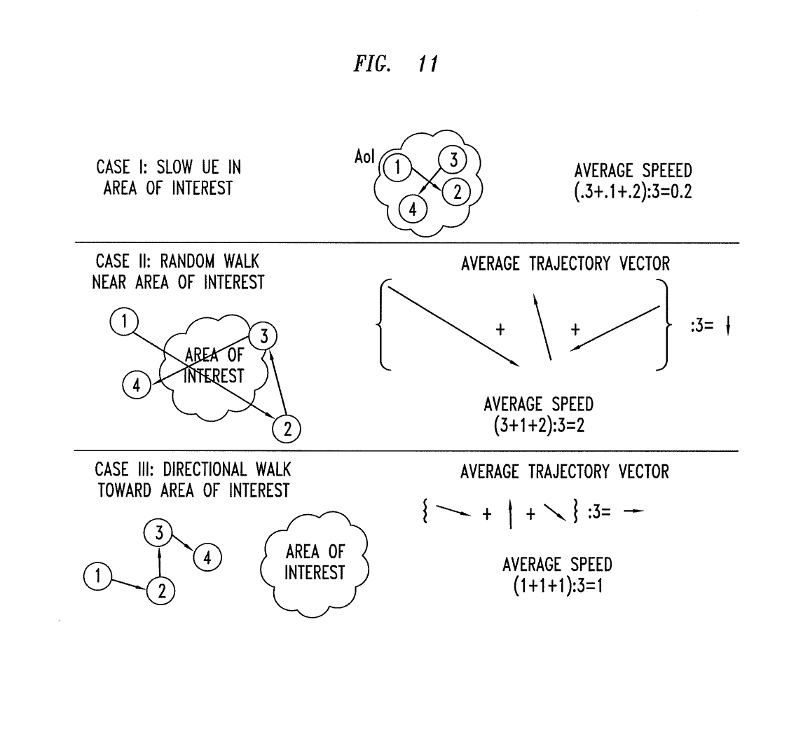

In at least some embodiments (which also may be referred to as AMuSe-MDT-Based-Reports), the FB mechanism may be realized using MDT-based reports. This option leverages the status messages supported by the MDT standard, where such status messages report RF measurements of the eMBMS service. The RF measurement information that is received from the UEs in the status messages is sufficient for AMuSe, however, each UE is configured separately rather than as a group using probabilistic instructions. It is noted that such embodiments require polling of each UE individually for obtaining the MDT reports of the UEs, which requires careful monitoring of all the eMBMS receivers in the MBSFN area and which also implies higher computational and communication overhead. It is further noted that such embodiments provide the advantage of the usage of standard protocols without the need to collaborate with other vendors. An example embodiment is depicted in FIG. 9, which depicts an embodiment of AMuSE configured to support targeted collection of feedback information from a wireless end device using AMuSe-MDT-Based-Reports. A corresponding method for use by a wireless end device for collecting feedback information under the control of a network device and reporting the feedback information to the network device is presented with respect to FIG. 10.

FIG. 10 depicts an embodiment of a method for use by a wireless end device for collecting feedback information under the control of a network device and reporting the feedback information to the network device using AMuSe-MDT-Based-Reports. It is noted that, although presented herein as being performed serially, at least a portion of the functions of method 1000 may be performed contemporaneously or in a different order than as presented in method 1000 of FIG. 10. It also will be appreciated that various portions of the functions of method 1000 may be split into separate processes or organized or implemented in other ways.

At block 1001, method 1000 begins.

At block 1010, the wireless end device receives, from a network device, an MDT request message including feedback collection instruction information. The MDT request message is received via a unicast from the network device to the wireless end device. The feedback collection instruction information may include an indication of the feedback information to be collected (e.g., wireless end device identification information, wireless end device location information, QoS information, or the like, as well as various combinations thereof), an indication of a feedback reporting rate at which feedback information is to be reported, or the like, as well as various combinations thereof. The MDT request message may include MDT configuration information for configuring the wireless end device to collect and report the feedback information based on the feedback collection instruction information.

At block 1020, the wireless end device collects feedback information. The wireless end device may collect the feedback information based on the feedback collection instruction information. The feedback information may include wireless end device identification information, wireless end device location information, QoS information (e.g., RF signal measurement information, information indicative of packets received and lost, or the like), or the like, as well as various combinations thereof.

At block 1030, the wireless end device sends, toward the network device, an MDT response message including the feedback information. The MDT response message is sent via a unicast from the wireless end device to the network device.

At block 1099, method 1000 ends.

In at least some embodiments, AMuSe may be configured to perform service quality evaluation. The service quality evaluation may include performing service quality analysis and making associated recommendations. The service quality evaluation may include inferring the eMBMS service quality, performing root cause analysis, making recommendations of parameter settings, or the like, as well as various combinations thereof.

In at least some embodiments, AMuSe may be configured to infer the eMBMS service quality. The collected FB information may be used for producing spatial and temporal reports of the quality of the provided eMBMS services. FIG. 6, as indicated above, presents an example of such a report which shows the UE distribution according to a specific service quality metric, such as the eMBMS SNR or the pre-FEC PDR. The report can be given in granularity of the entire service area, a specific cell, a sub-region in a cell coverage area, or the like.

In at least some embodiments, AMuSe may be configured to perform root cause analysis. The root cause analysis may be based on the UE feedback information. The root cause analysis may include service quality analysis (e.g., which may include packet loss analysis), anomaly detection, or the like, as well as various combinations thereof.

The root cause analysis may include service quality analysis. Recall that, in eMBMS, all the eNodeBs in the MBSFN area transmit identical multicast signals using the same MCS. This implies that the network utilization is dictated by the cell with the weakest service quality. As such, it is important to understand the reasons that some cells provide lower service quality than others. While it is typically possible to improve the service quality by reducing the eMBMS MCS, such approach may cause significant network capacity reduction throughout the entire MBSFN area. In practice, other alternatives may be more effective. It is noted that this may be further understood by way of the following example. In this example, assume that one cell provides considerably weaker service quality than the other cells. If the reason for this discrepancy is the cell size, which causes far UEs to suffer from poor channel condition, then the recommendation should be to reduce the MCS and in the long run redesigning the cell coverage. However, if the poor service results from interference caused by neighboring cells, then a better solution is to enhance the FEC and recommend that the protection tier be extended for reducing interferences. This example demonstrates that, in at least some cases, it is not sufficient to consider just the eMBMS SNR and to adjust the MCS accordingly, but, rather, that it may be useful to consider other metrics as well. For instance, in order to detect interference AMuSe may consider additional RF measurements (e.g., Reference Signal Received Power (RSRP) or the like) and perform packet loss analysis based on vectors of received/lost packets reported by the UEs.

The root cause analysis may include service quality analysis. Over time, the eMBMS system may suffer from gradual degradation of the service quality (e.g., due to a faulty component) or instantaneous service quality reduction (e.g., as a result of an equipment failure). In both cases, AMuSe may detects time varying changes in the service quality and provide possible causes for the situation. It is noted that such analysis also may consider several RF metrics as well as packet loss analysis.

In at least some embodiments, AMuSe may be configured to make recommendations of parameter settings. The recommendations may be based on the root cause analysis based on the UE feedback information. The recommendations may include recommendations for improving the network performance, while meeting SLA requirements. As illustrated by the example provided in conjunction with the root cause analysis functions of AMuSe, there is no one solution that fit all. For example, in case of poor service, the recommendations may include recommendations for an immediate remedy, such as eMBMS MCS or FEC tuning, and, if needed, also may include recommendations for long term solutions, like cell redesigning or modification of the protection tier.

As indicated above, AMuSe may be deployed in various ways (e.g., AMuSe-Off-Line or AMuSe-On-Line).

In at least some embodiments (denoted as AMuSe-Off-Line), for example, AMuSe may be used as a monitoring and reporting tool that collects service quality reports from the UEs and provides instantaneous static analysis of the UE experience and that also suggests eMBMS parameter configurations. AMuSe may provide static reports about the eMBMS service quality and recommended eMBMS settings and, in response, service providers may tune the eMBMS parameters according to their own discretion. It is noted that, although such embodiments are referred to as AMuSe-Off-Line, the information collecting and the reports are instantaneous. In at least some embodiments, AMuSe may be implemented as a component of the BMSC. This approach simplifies the integration of AMuSe with other eMBMS components. In at least some such embodiments, the AMuSe configuration can be done from information provided by the broadcast provisioning system (BPS).

In at least some embodiments (denoted as AMuSe-On-Line), for example, AMuSe may serve as a Self-Organizing Network (SON) tool for dynamic configuration of eMBMS parameters. The dynamic configuration of the eMBMS parameters may be based on the recommendations provided by AMuSe analysis. For allowing gradual deployment of this SON feature, AMuSe enables service providers to select the parameters that should be configured automatically and the ones that are set manually. AMuSe may be configured to dynamically change the eMBMS parameters without interruption to the service quality of the UEs by supporting synchronized configuration of several essential eMBMS parameters where immediate and correlated reaction is required. For instance, when poor service quality is detected, AMuSe may immediately (or nearly immediately) reduce the eMBMS MCS and enhance the FEC level. It will be appreciated that such operations typically also require synchronized modification of the video coding as well (for meeting the wireless resources allocation to eMBMS). In at least some embodiments of AMuSe-On-Line, MCS adaptation is achieved by sending appropriate work orders to a configuration tool which then which configures the MCEs of the eNodeBs. It is noted that, since all of the eNodeBs of the MBSFN send synchronized eMBMS signals, the MCS transition must be done by all the eNodeBs at the same time. In at least some embodiments, in order to ensure such a synchronized transition, a two-phase-commit type scheme may be used.

In at least some embodiments, as discussed above, AMuSe may be configured to perform feedback collection. AMuSe may be configured to collect sufficient service quality reports from the UEs, while ensuring low communication overhead. This objective is met by configuring or instructing UEs that suffer from low service quality to send frequent status reports, while configuring or instructing other UEs that enjoy high service quality to send infrequent and concise reports. AMuSe also may be configured to instruct the UEs regarding the feedback information to be provided, the measurement rate, and the feedback reporting rate. The feedback information may include UE identification information (e.g., Temporary Mobile Subscriber Identity (TMSI) or the like), UE location information (e.g., serving cell, neighboring cells, GPS location information, or the like), identity of the bearers monitored by the UE for collecting measurement information (e.g., the identities of the eMBMS bearers), RF signal measurement information (e.g., eMBMS SNR, RSRP, RSRQ, or the like), packet delivery information (e.g., pre-FEC and post-FEC packet delivery ratios (PDRs), information indicative of received and lost packets (e.g., a binary vector of received and lost packets), or the like), or the like, as well as various combinations thereof. The collection and reporting of UE feedback information, as noted above, may be performed based on Mobile-App (using Mobile-App-based feedback reports) or based on MDT-Based-Reports (using MDT-based feedback reports).

In at least some embodiments, collection and reporting of UE feedback information may be performed based on Mobile-App. These embodiments are based on installing a mobile application on the UEs.

In Mobile-App, feedback reporting may be performed as follows. AMuSe sends a light-weight multicast flow with instructions to all the eMBMS receivers, where the instructions indicate the feedback collection instruction information (e.g., feedback information to be provided, rate at which the feedback information is to be provided, or the like). This flow, which may be referred to as an AMuSe instruction flow, may be sent as an application layer eMBMS flow (e.g., where instructions are sent using an SML format). Here, each eMBMS receiver, in addition to listening to the selected eMBMS bearer, listens to the AMuSe instruction flow and decides, based on the AMuSe instruction flow, whether it should become a feedback node. A UE that serves as a FB node collects the required information (e.g., from the device drivers of the UE) and sends it to the network (e.g., to an AMuSe component for evaluation). For example, each FB node may send a specific number of feedback reports (e.g., 1, 2, 4, 5, 10, or the like) per second for a time period (e.g., 1 second, 2 seconds, 4 seconds, or the like) and then return to normal operation (not operating as a feedback node) until it is again selected as a feedback node.

In Mobile-App, feedback node selection may be performed as follows. The feedback node selection may be a stochastic quasi-distributed process based on the instructions in the AMuSe instruction flow and the service quality that the UEs experience. The UEs are partitioned into groups according to their eMBMS SNR and pre-FEC PDR. For each group of UEs, AMuSe specifies the probability that a UE should become a feedback node and the status information that UEs in this group should provide. By keeping track of the number of UEs in each group of UEs, AMuSe controls (i) the number of UEs that serve as FB nodes for each group and (ii) the expected overhead of feedback reports at any time. The process of feedback node selection, and the uplink overhead of the associated feedback messages, may be further understood with respect to the following example. In this example, assume that a UE experiences poor service quality if its eMBMS SNR is below 10 dB, moderate service quality when its eMBMS SNR is between 10 to 15 dB, and good service quality when its eMBMS SNR is above 15 dB. In this example, further assume that a cell has 2275 UEs that are divided into three groups as follows: (1) a High-FB-Rate (H-group) including 25 UEs, less than 2.5% of the UEs, that experience SNR below 10 dB and, thus, suffer from poor service, (2) a Medium-FB-Rate (M-group) including 250 UEs, about 10% of the UEs, with eMBMS SNR in the range 10 to 15 dB that experience moderate service quality, and (3) a Low-FB-Rate (L-group) including 2000 UEs (about 87% of the UEs) with SNR above 15 dB that enjoy good service quality. In this example, each second AMuSe instructs the UEs regarding the probability that the UEs should become feedback nodes. In this example, each UE that becomes a feedback node during a given second sends two feedback messages (it will be appreciated that fewer or more messages may be sent) during this second and then returns to operate as regular UE. It is noted that the time period that elapses between two successive events in which a UE is selected as a feedback node can be modeled as a negative binomial distribution with mean given by

$$mean ( p ) = \frac{p}{1 - p}$$

and standard deviation (STD) given by

$$STD ( p ) = \frac{\sqrt{p}}{1 - p} ,$$

where p is the probability that a UE switches to serve as a feedback node in a given second. In the example, above, if p=20%, 2%, and 0.25% for the H-group, M-group, and L-group, respectively, then the expected number of feedback messages that are sent by each group is 10 messages (e.g., 0.25% ×2000 UEs in the H-group results in 5 UEs reporting, 2%×250 UEs in the M-group results in 5 UEs reporting, and 20%×25 UEs in the L-group results in 5 of the UEs reporting) and, thus, the overall overhead is limited to 30 feedback messages per second. As such, in practice, even in dense UE populations, AMuSe can instruct the UEs to send a few feedback messages per cell (20-50 messages/cell), which implies quite a low communication overhead.

In Mobile-App, feedback collection at the UE may be performed using various monitoring elements at the UE. In at least some embodiments, third party tools may be used for obtaining the feedback information at the UE. For example, tools such as QUALCOMM eXtensible Diagnostic Monitor (which is a real-time data collection and diagnostic logging tool for measuring mobile-based RF performance and packet delivery information), ANDROID LogCat (which is a logging system for collecting and viewing system debug output and which can be used for obtaining both eMBMS SNR measurements as well as packet delivery information), TPC-Dump (which is a network layer sniffer application that monitors the traffic between the kernel and the applications, and which can be used for detecting packet delivery and loss information on Android devices), or the like may be used.

In at least some embodiments, collection and reporting of UE feedback information may be performed based on MDT-Based-Reports. These embodiments are based on extensions of the MDT standards to include additional messages that can be used by UEs for reporting the eMBMS service quality. In at least some embodiments, MBSFN Logged MDT messages can be used to report service quality evaluation to real-time eMBMS services. This may include UE location information, eMBMS RF measurements for signaling and data flow (e.g., RSRP, RSRQ, Multicast Channel Block-Error-Rate (MCH BLER), or the like), packet loss information, or the like as well as various combinations thereof. However, it is noted that such capabilities cannot be easily used for the following reasons: (1) the system needs to discover all of the UEs that enjoy eMBMS services and configure each one of them individually, (2) the system need to poll each individual UE for obtaining its collected measurements, (3) when polled, a UE provides all of its collected information which may include information that is not relevant, and (4) some of the desired information is not provided by MDT (e.g., eMBMS SNR). Accordingly, in at least embodiments, modified versions of the MDT-based feedback mechanism may be used for collection and reporting of UE feedback information. Two such variants, Fixed-MDT and Dynamic-MDT are described below.

In at least some embodiments, collection and reporting of UE feedback information may be performed based on MDT-Based-Reports using a variant of the MDT-based feedback mechanism referred to as Fixed-MDT. In at least some embodiments, Fixed-MDT configures all of the UEs with the same measurement configuration, which implies that all the UEs collect measurements at the same rate and that AMuSE polls all of the UEs at the same feedback reporting rate. If the feedback reporting rate is high, this means extensive up-link traffic. Otherwise, if the feedback reporting rate is low, considerable time may be needed to discover poor service areas and UEs that suffer from poor service.

In at least some embodiments, collection and reporting of UE feedback information may be performed based on MDT-Based-Reports using a variant of the MDT-based feedback mechanism referred to as Fixed-MDT.

In at least some embodiments, Dynamic-MDT may overcome inefficiencies of Fixed-MDT by keeping track of UEs near poor service areas (referred to as special UEs, whereas non-special UEs are referred to as regular UEs). Special UEs are configured to take frequent measurements and the system polls them often. By contrast, regular UEs collect sporadic measurements and are polled infrequently. This separation between special UEs and regular UEs enables the feedback mechanism to closely monitor the UEs that provide more essential information and reduce the uplink traffic of UEs that enjoy high service quality. It is noted that, in Dynamic-MDT, each UE is configured independently., which means that each time that a UE is selected to become a special UE or a special UE becomes a regular UE, the MDT configuration of the UE has to be updated (e.g., by sending RRC messages).

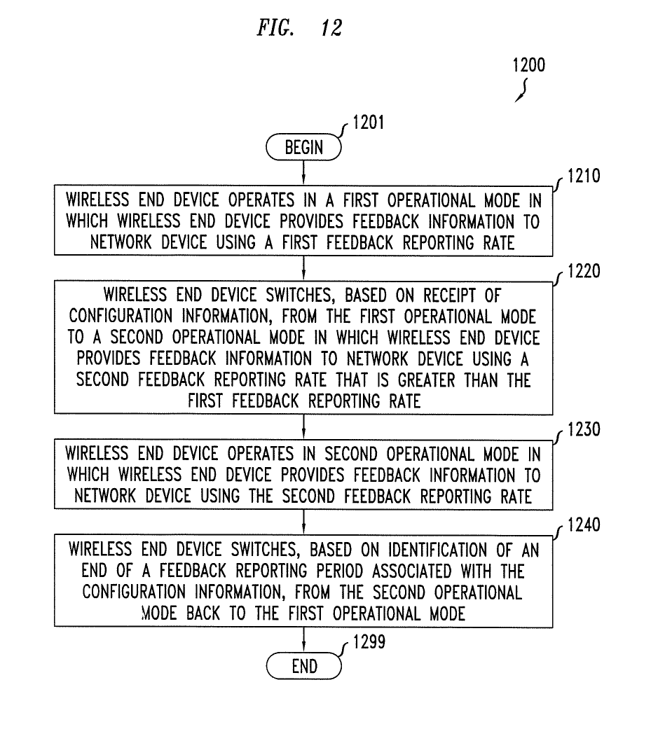

In Dynamic-MDT, as noted above, appropriate UEs are selected to be special UEs for feedback collection and reporting purposes. AMuSe may be configured to support a special UE selection process for selecting UEs to operate as special UEs. Here, assume that the system keeps track of areas without sufficient measurements or ones suspected as poor service areas (which are referred to as areas of interest (AoI)). The special UE selection process uses previous location reports of a UE to predict its future proximity to an AoI. The special UE selection process may monitor the following parameters of each UE collected from one or more recent feedback reports (e.g., two recent feedback reports, four recent feedback reports, or the like): (1) latest UE location, (2) average UE location, (3) average UE speed, and (4) average UE trajectory. The last two parameters may be calculated from the UE location reports as illustrated in FIG. 11. As depicted in FIG. 11, the special UE selection process may be configured such that a regular UE is selected as a special UE based on a determination that: (1) the UE is a slow moving UE located within the AoI, (2) the UE movement of the UE is a random walk near the AoI, or (3) the UE moves toward the AoI. It is noted that, in at least some embodiments, in order to bound the feedback overhead, only a portion of the UEs that satisfy the above conditions may be selected as special UEs for each AoI. The special UE selection process may be configured such that a special UE changes back to a regular UE based on a determination that the UE is moving away from an AoI.

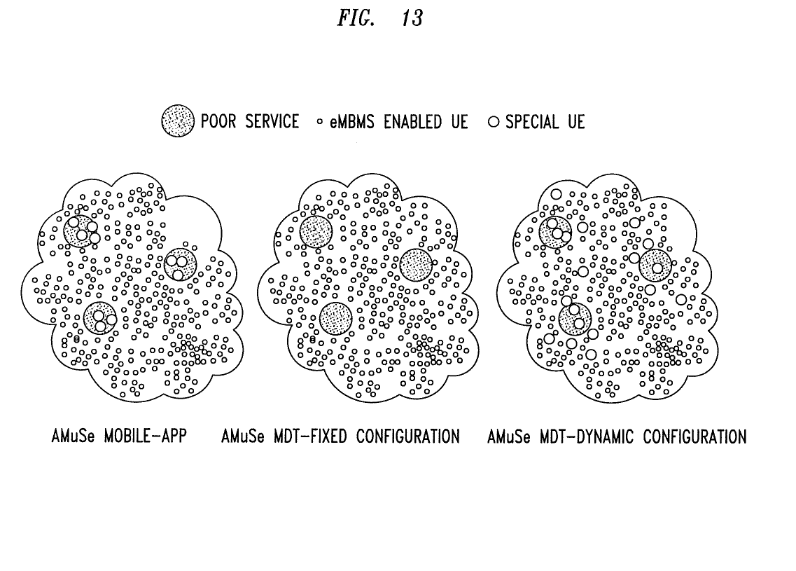

In Dynamic-MDT, as noted above, appropriate UEs are selected to be special UEs for feedback collection and reporting purposes. The UEs may be configured such that a UE, responsive to receiving an instruction to operate as a special UE, switches from a normal mode of operation (e.g., in which the UE collects and reports information at a first rate) to a special mode of operation (e.g., in which the UE collects and reports information at a second rate that is greater than the first rate). The UEs may be configured such that a UE, after being selected as a special UE and operating as a special UE for feedback collection and reporting purposes, the UE may revert back to operating in the normal mode either responsive to an instruction from the network or automatically (e.g., based on identification of the end of the feedback collection and reporting interval). An example embodiment of a method for use by a UE to switch from a normal mode of operation to a special mode of operation responsive to an instruction to operate as a special UE and to automatically switch from the special mode of operation back to the normal mode of operation is presented with respect to FIG. 12.

FIG. 12 depicts an embodiment of a method for use by a wireless end device for switching between normal and special modes of operation for collection of feedback information and reporting of the feedback information to a network device. It is noted that, although presented herein as being performed serially, at least a portion of the functions of method 1200 may be performed contemporaneously or in a different order than as presented in method 1200 of FIG. 12. It also will be appreciated that various portions of the functions of method 1200 may be split into separate processes or organized or implemented in other ways.

At block 1201, method 1200 begins.

At block 1210, the wireless end device operates in a first operational mode in which the wireless end device provides the feedback information to the network device using a first feedback reporting rate.

At block 1220, the wireless end device switches, based on receipt of configuration information, from the first operational mode to a second operational mode in which the wireless end device provides the feedback information to the network device using a second feedback reporting rate that is greater than the first feedback reporting rate. The configuration information may be received from the network device or other suitable device. The configuration information may be MDT configuration information or other suitable types of configuration information.

At block 1230, the wireless end device operates in the second operational mode in which the wireless end device provides the feedback information to the network device using the second feedback reporting rate.

At block 1240, the wireless end device switches, based on identification of an end of a feedback period associated with the configuration information, from the second operational mode back to the first operational mode. The feedback period or end of the feedback period may be specified in the configuration information, inferred or determined from the configuration information, known to the wireless end device in advance (e.g., based on some preconfigured feedback interval information), or the like.

At block 1299, method 1200 ends.

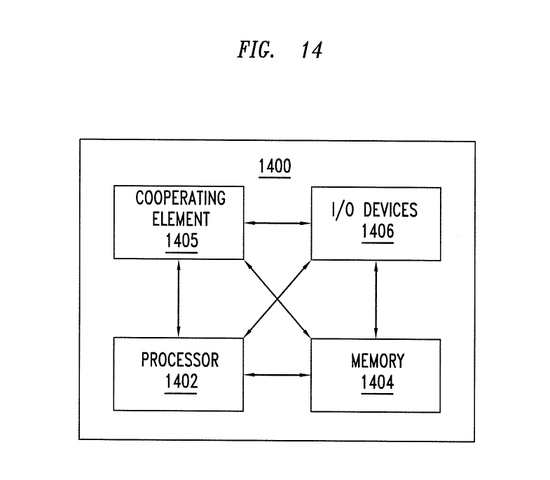

As discussed herein, AMuSe may be implemented using different feedback mechanism variants, including AMuSe Mobile-App, AMuSe Fixed-MDT Fixed, and AMuSe Dynamic-MDF. FIG. 13 depicts differences between the AMuSe feedback mechanism variants as reflected by the special UE locations. In the AMuSe Mobile-App variant, the special UEs are UEs that suffer from relatively poor service. In the AMuSe Fixed-MDT variant, there are no special UEs because all UEs are polled at the same rate. In the AMuSe Dynamic-MDT variant, the special UEs are scattered inside and around the AoIs, since special UEs may move away from the AoIs they visited before.

In at least some embodiments, as noted above, AMuSe may be configured to perform service quality evaluation. The service quality evaluation may include performing service quality analysis and making associated recommendations. The service quality evaluation may include estimating the service quality, performing root cause analysis, making recommendations of parameter settings, or the like, as well as various combinations thereof.

In at least some embodiments, AMuSe may be configured to perform service quality estimation. AMuSe may estimate the eMBMS service quality from the limited feedback information provided by the UEs. The service quality that an UE experience is a time varying function which depends on various effects such as the time, the UE location, and the device type.

The operation of AMuSE in performing service quality estimation may be based on various assumptions. For example, for analysis consider only those UEs that use eMBMS services and assume that those UEs consume the service for a relatively long duration. Additionally, it is assumed that, in spite of UE mobility and fluctuation of the RF signal, the distribution of the service quality of a given area is relatively static during a short time period (e.g., T=5 minutes). Additionally, it is assumed that, during this period, AMuSe collects a sufficient number of measurements for accurately inferring the service quality distribution. It will be appreciated that at least some such assumptions may be modified or removed.

In at least some embodiments, AMuSe may be configured to perform service quality estimation based on partitioning of the MBSFN area into a grid. For example, for managing the collected information and producing QoS reports with different special granularity, the MBSFN area may be divided into a square grid in which each square, also termed a tile, defines a small sub-area of size D×D, for a given length D (e.g., 10 meters, 20 meters, or the like). The feedback reports of UEs located in a given tile are aggregated and are used to infer the service quality distribution in the given tile area. It is noted that an area with poor service quality (i.e., an AoI) can be further divided into smaller tiles (e.g., 5×5 meters, 7×7 meters, or the like) for finer analysis.

In at least some embodiments, AMuSe may be configured to perform service quality estimation by estimating the service quality of an area. AMuSe may estimate the service quality of each tile in an MBSFN area. There are multiple sources of variance in this estimation problem. There is variance of SNR for the same UE due to random fluctuations in signal strength and movement of the UE within the same square. There is also inter-UE variance due to different receiver sensitivities, and the different relative positions of UEs within the same square. The first type of variance can be reduced by increased sampling of the UE; however, it may be difficult or even impossible to reduce the second type of variance since the number of UEs that can be observed is dependent on the movement of UEs into and out of the tile (which probably cannot be controlled in most cases). It is noted that different estimation methods for the mean and variance of service quality are available, depending on whether the distribution of service quality of a square follows certain parametric distributions. If drive-testing data is available, the drive-testing data can be incorporated as priors for the service qualities in the estimation process. Since in AMuSe there is a particular interest in UEs and areas with low service quality, the sampling rates for these UEs and areas are increased for more accurate quality estimates. By using a sliding window approach, in which only measurements collected during the last T minutes are considered, AMuSe can provide both the temporal and spatial statistics of the service quality.

In at least some embodiments, AMuSe may be configured to perform service quality estimation by estimating the number of outliers. As noted above, it was assumed that eMBMS receivers listen to the service for a relatively long duration; however, this may not be the case for outliers. Users that experience poor service quality tend to terminate the eMBMS application. In such situations, their UEs cease sending feedback reports to AMuSe, which may cause an incorrect estimation of the number of outliers. In at least some embodiments, to overcome this problem, AMuSe carefully monitors all of the outliers. Each outlier continues to send frequent feedback reports for a short duration (e.g., one minute, three minutes, or the like) even after its service quality is improved. As a result, when AMuSe stops receiving feedback reports from an outlier, it assumes that the user terminated the eMBMS application and, thus, that the UE does not send any additional feedback messages. This UE, although it is no longer an eMBMS receiver, is still considered as an outlier in its last reporting area for a while or until the UE resumes sending feedback reports. This time duration may be determined by the mobility pattern of the UEs.

In at least some embodiments, AMuSe may be configured to perform root cause analysis. As previously described, the SLA requirement puts an upper bound on the number of UEs that may suffer from poor service (the example provided above with respect to root cause analysis illustrates that the eMBMS service quality depends on multiple factors. Thus, it is important to identify the causes for poor service in order to determine the proper solution.

The various reasons for poor service quality may be classified into three categories as follows: poor channel condition, interference, and UE mobility.

With respect to poor channel condition, it is noted that, when there is poor channel condition, too many UEs suffer from low RF signals and, thus, have low eMBMS SNR. The reasons for this may include coverage issues due to inappropriate cell dimensioning, environmental changes such as new obstacles, equipment failures, equipment malfunctioning (unlike equipment failure, which is instantaneous, some equipment malfunctioning may be gradual and, thus, difficult to detect), or the like. The immediate short-term solution to such situations is reducing the MCS; however, identifying the source of the problem is essential for proper repair. Some of these issues may be reported by other monitoring means of the unicast services; however, due to the lack of packet retransmissions (i.e., HARQ) eMBMS services are more susceptible to such situations. For example, environmental changes and equipment malfunctioning may not be easily detected.

With respect to interference, it is noted that interference may cause sporadic service quality reduction to numerous UEs. It is expected that most of the interferences will be LTE transmissions from neighboring cells, but interference also may be created by other noise sources. The immediate remedy is extending the FEC (and also reducing MCS), while the long term solution is identifying the interference sources and extending the protection tier where needed.

With respect to UE mobility, it is noted that the eMBMS system may violate the SLA requirement if too many UEs move to areas with poor service. Conceptually, this event is similar to poor channel condition and may can be solved by adapting the MCS. However, frequent MCS changes hinders the service quality, so the service provider should have a policy to deal with such situations.

In at least some embodiments, AMuSe may be configured to perform root cause analysis by distinguishing between poor channel condition and interference. In at least some embodiments, AMuSe may be configured to distinguish between poor channel condition and interference by identifying interference.

In at least some embodiments, AMuSe may be configured to identify interference based on a combination of eMBMS SNR and RSRP information. Poor service is generally characterized by low eMBMS SNR (or Signal to Noise and Interference Ratio (SINR)). There are two fundamental reasons for having low SNR: (1) the received signal strength is low, which indicates poor channel condition or (2) the noise level is too high, which implies interference. AMuSe may distinguish between these two situations by evaluating RSRP.

In at least some embodiments, AMuSe may be configured to identify interference based on packet loss analysis. It is noted that interference is typically characterized as burst of noise that causes correlated losses of packets. AMuSe may receive, from the UEs, binary vectors of correctly received or lost packets and may evaluate the binary vectors of correctly received or lost packets to determine whether packet losses in a given area are correlated. AMuSe may be configured to detect interference on the basis of the determination as to whether packet losses in a given area are correlated. AMuSe also may be configured to use pattern recognition capabilities to identify the noise source(s) when interference is detected.

In at least some embodiments, AMuSe may be configured to perform root cause analysis by performing anomaly detection. In some situations, eMBMS service quality may suffer from a sharp reduction of its quality. This may occur in the case of failed/malfunctioning equipment or when a noise source starts to operate in the vicinity of the MBSFN area. AMuSe may be configured to quickly detect and report such events. This may be considered to be anomaly detection. Typically, such anomalies impact multiple adjacent tiles simultaneously. AMuSE may be configured to detect such events by monitoring the expected service quality at each of the tiles. AMuSe may be configured to, based on a determination that the service quality reports at a given tile are significantly below the expected service quality level within a relatively short period of time (e.g., Δ<<T, Δ=30 seconds), determine if any adjacent tiles suffer from similar service quality reduction and, based on a determination that an adjacent tile(s) suffers from similar service quality reduction, report the anomaly.

In at least some embodiments, AMuSe may be configured to make recommendations of parameter settings. For example, given a service quality distribution estimate, AMuSe may be configured to recommend new eMBMS parameters to improve the performance of the system.

In at least some embodiments, AMuSe may be configured to make recommendations of parameter settings based on decision rules. This may include defining manual decision rules for suggesting what to do given a certain service quality distribution. For instance, after inferring the eMBMS SNR, as shown in FIG. 6, AMuSe can determine the maximal permitted SNR threshold that meets the SLA requirement (i.e., the SNR Threshold ensures that at least fraction X of the UE population experiences SNR equal to or greater than the SNR threshold). AMuSe may be configured to, after the SNR threshold is selected, tunes the eMBMS parameters (e.g., MCS and possibly others) accordingly using an eMBMS parameter tuning capability (e.g., using a commonly accepted mapping or the like). It is noted that, while this approach is relatively simple to implement, it may not be robust against changes in environmental factors (e.g., even with a detailed pre-deployment drive test, the environmental conditions can change over time and previous optimal parameter settings can become outdated).

In at least some embodiments, AMuSe may be configured to make recommendations of parameter settings based on learning mechanisms. This may include use of learning (e.g., reinforcement learning or the like) to experiment and to determine various parameter settings that can improve the overall service quality. For example, reinforcement learning may be used to learn the best actions to take in each state in an unknown environment, evaluated through some task-specific value function. Using the overall service quality as value function and the service quality distribution estimate as state, reinforcement learning algorithms may be applied to iteratively explore which MCS and FEC optimizes the objective. It is noted that, while this approach is able to adapt parameters to a dynamic environment, implementation may be challenging and, thus, it may be useful to restrict the allowable actions (MCS and FEC settings) so as not to disrupt the system in a dramatic manner (e.g., only allowing MCS and FEC to change in small increments within a fixed range).

It will be appreciated that, although primarily presented with respect to embodiments in which AMuSe uses either decision rules or learning to make recommendations of parameter settings, in at least some embodiments AMuSe may be configured to use on a combination of rules and learning to make recommendations of parameter settings.

It will be appreciated that eMBMS parameters provide different trade-offs to service operators for selecting preferred solution. For instance, increasing the multicast MCS may be used for reducing the wireless resources allocated to the multicast flows or to improve the video quality (i.e., resolution) provided to the UE. Alternatively, choose between wide MBSFN protection tier and higher level of FEC may be used for handling interference. It is noted that the decisions between these trade-offs may depend on policies provided by the service operators.

As discussed herein, various embodiments of AMuSe may be configured to support various functions for collection of feedback information, analysis of the feedback information, and recommendations of parameter settings. The various embodiments of AMuSe may be realized in various ways. Generally speaking, AMuSe is a monitoring and management solution of which may be used in an eMBMS system, in which case it may interact with various other eMBMS components for its operation. The operation of AMuSe may be further understood by considering one such implementation of AMuSe in which AMuSe is implemented in an eMBMS architecture having distributed MCE (e.g., an MCE element on each eNodeB), as an element of the MBCS. It is noted that, while the description of this AMuSe implementation which follows is primarily based on embodiments of AMuSe-On-Line, portions of the description of this AMuSe implementation which follows also may be applicable for embodiments of AMuSe-Off-Line (e.g., in which case a subset of the described extensions of the eMBMS architecture—the AMuSe provisioning element, the AMuSe feedback element, and the AMuSe reporting element—may be used).

In at least some embodiments, AMuSe may be realized using AMuSe provisioning capabilities. In at least some embodiments, the AMuSe configuration is an extension of the BNICS settings combined with AMuSe specific information. It is noted that this may be done from information provided by the broadcast provisioning system (BPS) as well as additional configuration parameters provided by other configuration tools. The BPS generates user service descriptions (USDs) files that specify the eMBMS service information. While the configuration tools may provide additional details about the eMBMS system (e.g., current MCS of the eMBMS service), the AMuSe configuration may include the following information: (1) monitored eMBMS services (e.g., service location (e.g., service area), start and end time, video source, eMBMS bearer (e.g., both for multimedia traffic as well as AMuSe instructions), required SLA constraints (e.g., specifying the expected service quality that AMuSe is required to verify and preserve, in particular an upper bound on the portion of UEs which may suffer from unsatisfying service quality), or the like, (2) other eMBMS network components (e.g., AMuSe provides communication information to other eMBMS components (e.g., eMBMS configuration and reporting tools, eNodeBs in the MBSFN, or the like), and (3) operator policies for AMuSe operation and its dynamic configuration process (e.g., configuration aspects may include (i) the operation ranges of eMBMS parameters (e.g., MCS and FEC), (ii) the upper bounds on AMuSe overhead on the downlink and uplink traffic, (iii) the operator preferred feedback mechanism, (iv) the operator configuration parameters for the selected AMuSe feedback mechanism, and (v) the operator preferred solutions for various scenarios such as trade-off between resource usage and video quality enhancement).

In at least some embodiments, AMuSe may be realized using initial eMBMS parameter setting capabilities. In at least some embodiments, AMuSe uses an iterative mechanism to tune the eMBMS parameters like the MCS index. The choice of the initial MCS setting is important. As previously indicated, in a given MBSFN area, out-of-cell interference in unicast becomes a useful signal in eMBMS. In general, the unicast SNR is a lower bound to the eMBMS SNR. So, the unicast SNR (which is available as a part of the already existing feedback in unicast schemes) may be used as the initial MCS setting for the AMuSe iterations.

In at least some embodiments, AMuSe may be realized using eMBMS receiver information collection capabilities. It is noted that a challenge when using the MDT-based feedback mechanism is knowing the identities of all the eMBMS receivers in the service area. In such a configuration, AMuSe may keep track of all of the eMBMS receivers in the service area and configure each of the eMBMS receivers separately regarding the desired feedback information and the desired feedback measurement rate and feedback reporting rate. Since eMBMS receivers may be UEs in IDLE mode without connections with eNodeBs, as discussed further below, various additional considerations (e.g., eMBMS Consumption Reports Messages (CRMs), Group Communication System (GCS), or the like) may be used to detect the eMBMS receivers in the service area, such as the ones described below.

In at least some embodiments, AMuSe may be configured to detect the eMBMS receivers in the service area based on eMBMS CRMs. The eMBMS protocol supports a set of messages, termed consumption reports, which enable eMBMS receivers to inform the BMSC that they are consuming eMBMS services. The eMBMS service consumption reporting procedure is initiated by the MBMS receiver to the BMSC, in accordance with parameters in the Associated Delivery Procedure (ADP) description provided in the user service description (USD). The eMBMS protocol allows various triggers for sending consumption reports, including when a UE starts/ends the eMBMS service or periodically.

In at least some embodiments, AMuSe may be configured to detect the eMBMS receivers in the service area based on GCS. In general, GCS is designed to provide a fast and efficient mechanism to distribute the same content to multiple users in a controlled manner. GCS enables UEs to communicate with a GCS Application Server (AS) and to obtain desired content as an unicast flow or as eMBMS flow. Thus, GCS AS can provide the list of eMBMS receivers that listen to an eMBMS flow.

It is noted that, in addition to CRMs and GCS, additional mechanisms may include: (1) BMSC Membership Function (defined for MBMS services, but not required for LTE-eMBMS) or (2) Digital Rights Management (DRM) System (e.g., for billing purposes, UEs may interact with the operator DRM system for obtaining the proper keys for decoding the eMBMS services; however, service providers typically have their own DRM system which is not part of the eMBMS system).

In at least some embodiments, AMuSe may be realized using dynamic parameter setting capabilities.

In at least some embodiments, an objective of AMuSe may be to improve or optimize the LTE network performance, while ensuring high service quality to the UEs. This objective may be achieved by tuning the eMBMS transmission parameters, mainly the MCS and the FEC. Recall that each time AMuSe changes these eMBMS transmission parameters, the wireless resources consumption of the eMBMS service is affected as well. For instance, when the eMBMS MCS is increased, some of the wireless resources allocated for the service are not needed and, thus, can be released. Alternatively, the service provider may prefer to improve the video quality by instructing the content server to increase the video resolution. Similarly, before the eMBMS MCS is reduced, the wireless resources may be increased or the video resolution may be reduced, for matching the content bandwidth requirements to the available wireless resources.

In at least some embodiments, as noted above, AMuSe may be configured to use a two-phase-commit-like modification process in order to dynamically modify parameter settings. As noted above, a potential challenge of dynamic configuration is changing the eMBMS parameters, while ensuring high QoE to the users and without interruption to the eMBMS service. The MCS adaptation may be achieved by sending appropriate work orders to a configuration tool, which updates the MCEs of the eNBs with the new eMBMS MCS. Since all the eNBs of the MBSFN set send identical and synchronized eMBMS signals, any eMBMS MCS change must be done at all of the eNBs contemporaneously (i.e., at or near the same time). In at least some embodiments, this may be achieved using a two-phase-commit-like modification process, which may be based on the fact that the clocks of the eNBs are synchronized and based on an assumption that the round-trip propagation delay between the configuration tool and each of the eNBs is upper bounded by τ. The configuration tool may contemporaneously sends instructions to the eNBs to inform the eNBs to change the eMBMS MCS at some parameter change time (e.g., at least 3τ time units away). The eNBs, responsive to the respective instructions, may send respective acknowledgement (ACK) messages for the respective instructions. The configuration tool, based on a determination that ACKs are received from all of the eNBs in the MBSFN within a time period of 2τ, may send a commit message to all of the eNBs. The configuration tool, based on a determination that ACKs are not received from all of the eNBs in the MBSFN within a time period of 2τ, rather than sending the commit message to the UEs, sends an abort message to all the eNBs. The configuration tool may then repeat the process with a longer parameter change time (e.g., 5τ, 7τ, or the like).

In at least some embodiments, AMuSe may be activated and operated in various ways. Here, assume that each eMBMS receiver is equipped with AMuSe-Mobile-App (although it will be appreciated that activation and operation of AMuSe when using an MDT-based feedback mechanism is similar). The activation and operation process is described in general terms and allows use of various processes or algorithms for determining (1) AMuSe instructions, (2) UE feedback reporting rates, (3) various control parameters (such as mₛₚₗᵢₜ and m_{merge}) and (4) other configuration aspects. First, before activating any eMBMS service, both the eMBMS service and AMuSe are configured based on AMuSe provisioning discussed above. AMuSe is activated at or near the same time that the eMBMS service starts. The AMuSe-Mobile-App may be integrated into the eMBMS receiver application of the UE such that, when the eMBMS application is activated, the AMuSe-Mobile-App also is activated. Initially, each activated UE just listens to the eMBMS service, evaluates the service quality, and waits to receive AMuSe instructions. Upon activation, the system does not include any eMBMS receivers. So, initially, AMuSe instructs each eMBMS receiver that joins the eMBMS service to evaluate the service quality that it experience and send an associated report. AMuSe uses these reports for estimating the service quality distribution. As more UEs join the eMBMS service, AMuSe gradually reduces the report rate of the UEs to meet the given upper bound on AMuSe overhead. When the number of eMBMS receivers exceeds a given threshold, say mₛₚₗᵢₜ, AMuSe splits the eMBMS receivers into two (or more) groups such that UEs that experience relatively low service quality report at higher rates than UEs that experience relatively high service quality. When the number of eMBMS receivers falls below a given threshold, termed m_{merge} where m_{merge}<mₛₚₗᵢₜ, AMuSe merges the UE groups into one group and all the UEs send reports at the same rate (e.g., determined by the number of eMBMS receivers). AMuSe stops sending instructions to the UEs when the eMBMS service terminates.

Various embodiments of AMuSe, as discussed herein, may be configured to support efficient video delivery to large groups of UEs by using LTE eMBMS services. AMuSe efficiently collects UE reports about provided eMBMS services, analyzes the UE reports, provides recommendations for optimizing network performance, and dynamically tunes the eMBMS network parameters while ensuring high quality of experience to the users.

Various embodiments of AMuSe may be configured to provide various advantages or potential advantages. Various embodiments of AMuSe may obviate the need to provide dense deployment of access points (APs) or base stations (BSs), which requires high capital and operational expenditures and which may suffer from extensive interference due to the density of deployment of the access devices, in order to address the growing demand for multimedia content delivery (e.g., video streaming). Various embodiments of AMuSe may overcome various deficiencies or disadvantages of existing wireless multicast solutions (e.g., such as where multicast services are provided without QoS guarantees due to lack of UE feedback and, thus, limited multicast services are provided at relatively low bit rate (e.g., 6 Mbps for 802.11a/g). Various embodiments of AMuSe may overcome various deficiencies or disadvantages of existing mechanisms for collecting feedback from UEs (e.g., high feedback overhead associated with individual feedback mechanisms, feedback tuning according to receivers with the worst channel condition and lack of QoS guarantees with leader based feedback mechanisms, or the like). Various embodiments of AMuSe may overcome various deficiencies or disadvantages of existing eMBMS services (e.g., lack of a comprehensive planning methodology (such that planning is done based on imprecise models), extensive and time consuming field trials (in which a rigorous RF survey may yield limited information from a few monitoring devices), the need for use of conservative deployments (e.g., eMBMS parameters such as MCS and FEC are set to conservative values) which hamper system performance, lack of support for handling environmental changes (e.g., there is no way to infer degradation in the services quality due to malfunctioning equipment or due to environmental changes such as new obstacles or interference sources), and so forth. Various embodiments of AMuSe may overcome various deficiencies or disadvantages of existing mechanisms for supporting dynamic tuning of eMBMS parameters (e.g., obtaining accurate service quality reports with low overhead, selection of MCS that satisfies the receiver with the worst channel condition (thereby preventing implementation of a multicast scheme having high utilization while ensuring reliable delivery to all UEs), and so forth). Various embodiments of AMuSe may be configured to provide simple and efficient solutions without various weaknesses associated with existing eMBMS solutions (e.g., a requirement for feedback from large numbers of receivers, an inability to provide QoS guarantees, low network utilization, a requirement for changes to the standards, expensive deployment, and so forth). Various embodiments of AMuSe may be configured to provide various other advantages or potential advantages.

FIG. 14 depicts a high-level block diagram of a computer suitable for use in performing various functions presented herein.

The computer 1400 includes a processor 1402 (e.g., a central processing unit (CPU), a processor having a set of processor cores, a processor core of a processor, or the like) and a memory 1404 (e.g., a random access memory (RAM), a read only memory (ROM), or the like). The processor 1402 and the memory 1404 are communicatively connected.

The computer 1400 also may include a cooperating element 1405. The cooperating element 1405 may be a hardware device. The cooperating element 1405 may be a process that can be loaded into the memory 1404 and executed by the processor 1402 to implement functions as discussed herein (in which case, for example, the cooperating element 1405 (including associated data structures) can be stored on a non-transitory computer-readable storage medium, such as a storage device or other storage element (e.g., a magnetic drive, an optical drive, or the like)).

The computer 1400 also may include one or more input/output devices 1406. The input/output devices 1406 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 1400 of FIG. 14 may represent a general architecture and functionality suitable for implementing functional elements described herein, portions of functional elements described herein, or the like, as well as various combinations thereof. For example, computer 1400 may provide a general architecture and functionality that is suitable for implementing all or part of one or more of the various devices and elements presented herein.

It will be appreciated that at least some of the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
identify, from a set of wireless end devices served by a wireless access device, a special wireless end device from which feedback information is to be collected;
send, toward the special wireless end device, minimization of drive test (MDT) configuration information for configuring the special wireless end device to collect the feedback information; and
receive, from the special wireless end device, the feedback information collected by the special wireless end device.

2. The apparatus of claim 1, wherein, to identify the special wireless end device, the processor is configured to:
determine, based on location information associated with the special wireless end device, that the special wireless device satisfies a condition associated with an area of interest (AOI).

3. The apparatus of claim 2, wherein the AOI comprises a geographical region for which a number of feedback reports from the wireless end devices served by the wireless access device fails to satisfy a threshold.

4. The apparatus of claim 2, wherein the AOI comprises a geographical region identified, based on a set of feedback reports from the wireless end devices served by the wireless access device, as having a quality of service failing to satisfy a threshold.

5. The apparatus of claim 2, wherein the location information associated with the special wireless end device is determined based on a set of previous location reports received from the special wireless end device.

6. The apparatus of claim 5, wherein the location information associated with the special wireless end device comprises predicted location information associated with the special wireless end device, wherein the processor is configured to:
determine the predicted location information associated with the special wireless end device by predicting a future location or movement of the special wireless end device based on the set of previous location reports received from the special wireless end device.

7. The apparatus of claim 2, wherein the location information associated with the special wireless end device comprises a current location of the special wireless end device, an average location of the special wireless end device, an average speed of the special wireless end device, and an average trajectory of the special wireless end device.

8. The apparatus of claim 2, wherein the condition associated with the AOI comprises at least one of:
a determination that the special wireless end device is located within the AOI,
a determination that a movement pattern of the special wireless end device is a random walk within or near the AOI, or
a determination that the special wireless end device is moving toward the AOI.

9. The apparatus of claim 1, wherein the MDT configuration information comprises at least one of an indication of an information type of the feedback information, an indication of a collection rate at which the feedback information is to be collected, or an indication of a feedback reporting rate at which the feedback information is to be reported.

10. The apparatus of claim 1, wherein the processor is configured to send the MDT configuration information in an MDT message.

11. The apparatus of claim 1, wherein the feedback information comprises at least one of identification information of the special wireless end device, location information of the special wireless end device, identification of one or more bearers with which the feedback information is associated, radio frequency measurements of the special wireless end device, or packet loss information of the special wireless end device.

12. The apparatus of claim 11, wherein the radio frequency measurements of the special wireless end device comprise evolved Multimedia Broadcast/Multicast Service (eMBMS) radio frequency measurements.

13. The apparatus of claim 1, wherein the processor is configured to receive the feedback information in a Multicast Broadcast Single Frequency Network (MBSFN) Logged MDT message.

14. The apparatus of claim 1, wherein the processor is configured to:
perform a service quality evaluation based on the feedback information.

15. The apparatus of claim 1, wherein the processor is configured to:
estimate, based on the feedback information, spatial and temporal service quality experienced by the set of wireless end devices served by the wireless access device.

16. The apparatus of claim 1, wherein the processor is configured to:
infer, based on the feedback information, at least one of:
a fraction of wireless end devices in the set of wireless end devices experiencing service quality that fails to satisfy a service quality threshold; or
one or more service locations, in a service area of the wireless access device, with a service quality that fails to satisfy a service quality threshold.

17. The apparatus of claim 1, wherein the processor is configured to:
determine, based on the feedback information, a setting for a multicast-broadcast service parameter.

18. The apparatus of claim 17, wherein the multicast-broadcast service parameter comprises a modulation and coding scheme (MCS) parameter, a forward error correction (FEC) parameter, a video coding parameter, or a protection tier parameter.

19. The apparatus of claim 17, wherein the processor is configured to:
send the setting for the multicast-broadcast service parameter toward at least one of a network component or a multicast-broadcast service provisioning mechanism.

20. A non-transitory computer-readable storage medium storing instructions which, when executed by a computer, cause the computer to perform a method, the method comprising:
identifying, from a set of wireless end devices served by a wireless access device, a special wireless end device from which feedback information is to be collected;
sending, toward the special wireless end device, minimization of drive test (MDT) configuration information for configuring the special wireless end device to collect the feedback information; and
receiving, from the special wireless end device, the feedback information collected by the special wireless end device.

21. A method, comprising:
identifying, by a processor from a set of wireless end devices served by a wireless access device, a special wireless end device from which feedback information is to be collected;
sending, by the processor toward the special wireless end device, minimization of drive test (MDT) configuration information for configuring the special wireless end device to collect the feedback information; and
receiving, by the processor from the special wireless end device, the feedback information collected by the special wireless end device.

22. A wireless end device configured to provide feedback information to a network device, comprising:
a processor and a memory communicatively connected to the processor, the processor configured to:
operate in a first mode in which the wireless end device provides the feedback information to the network device using a first feedback reporting rate;
switch, based on receipt of configuration information, from the first mode to a second mode in which the wireless end device provides the feedback information to the network device using a second feedback reporting rate that is greater than the first feedback reporting rate;
operate in the second mode in which the wireless end device provides the feedback information to the network device using the second feedback reporting rate; and
switch, based on identification of an end of a feedback period associated with the configuration information, from the second mode to the first mode.
